(19) United States
(12) Patent Application Publication
(10) Pub. No.: US 2011/0211595 A1
(43) Pub. Date: Sep. 1, 2011

(54) METHOD AND APPARATUS TO FACILITATE AN EARLY DECODING OF SIGNALS IN RELAY BACKHAUL LINKS

(75) Inventors: Stefan Geirhofer, San Diego, CA (US); Tao Luo, San Diego, CA (US); Ravi Palanki, San Diego, CA (US); Wanshi Chen, San Diego, CA (US); Juan Montojo, San Diego, CA (US)

(73) Assignee: QUALCOMM Incorporated, San Diego, CA (US)

(21) Appl. No.: 13/022,389

(22) Filed: Feb. 7, 2011

Related U.S. Application Data
(60) Provisional application No. 61/305,093, filed on Feb. 16, 2010.
(60) Provisional application No. 61/312,595, filed on Mar. 10, 2010.
(60) Provisional application No. 61/322,785, filed on Apr. 9, 2010.

(51) Int. Cl. H04J 4/00; H04L 27/06; H04J 1/00

(52) U.S. Cl. 370/478; 375/340; 370/480

(57) ABSTRACT

Methods, apparatuses, and computer program products are disclosed that facilitate an early decoding of relay signals. A relay receives a signal within a sub-frame from a network. A first and second reference symbol is detected within the sub-frame such that the first reference symbol is detected before the second reference symbol. The signal is then decode based on the first reference symbol.

### CROSS-REFERENCE TO RELATED APPLICATIONS

This application claims the benefit of U.S. Provisional Patent Application Ser. No. 61/305,093 entitled “EARLY DECODING TECHNIQUES FOR CONTROL CHANNELS OF RELAY BACKHAUL LINKS,” which was filed Feb. 16, 2010, U.S. Provisional Patent Application Ser. No. 61/312,595 entitled “EARLY DECODING TECHNIQUES FOR CONTROL CHANNELS OF RELAY BACKHAUL LINKS,” which was filed March 10, 2010, and U.S. Provisional Patent Application Ser. No. 61/322,785 entitled “EARLY DECODING TECHNIQUES FOR CONTROL CHANNELS OF RELAY BACKHAUL LINKS,” which was filed Apr. 9, 2010. The aforementioned applications are herein incorporated by reference in their entirety.

### BACKGROUND

1. Field

The following description relates generally to wireless communications, and more particularly to methods and apparatuses that facilitate an early decoding of relay signals.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Tenn Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

With respect to decoding signals at a relay node, it is often desirable to perform such decoding as early as possible upon receiving a particular sub-frame or portion thereof. Accordingly, methods and apparatuses that facilitate an early decoding of relay signals are desirable.

The above-described benefits of early decoding are merely intended to provide a perspective on some of the problems conventional systems may face if this aspect is not properly incorporated into system design, and are not intended to be exhaustive. Other problems/challenges with conventional systems and corresponding benefits of the various non-limiting embodiments described herein may become further apparent upon review of the following description.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with an early decoding of relay signals. In one aspect, methods and computer program products are disclosed that facilitate an early processing of relay signals. These embodiments include receiving a signal within a sub-frame. For these embodiments, the received signal is associated with a relay. These embodiments further include detecting a first reference symbol and a second reference symbol within the sub-frame, such that the first reference symbol is detected before the second reference symbol. A decoding of the signal is performed based on the first reference symbol.

In another aspect, an apparatus configured to facilitate an early processing of relay signals is disclosed. Within such embodiment, the apparatus includes a processor configured to execute computer executable components stored in memory. The computer executable components include a communication component, a reference component, and a decoding component. The communication component is configured to receive a signal within a sub-frame, whereas the reference component is configured to detect a first reference symbol and a second reference symbol within the sub-frame. For this embodiment, the signal is associated with a relay, and the first reference symbol is detected before the second reference symbol. The decoding component is configured to decode the signal based on the first reference symbol.

In a further aspect, another apparatus is disclosed. Within such embodiment, the apparatus includes means for receiving, means for detecting, and means for decoding. For this embodiment, the means for receiving is configured to receive a signal within a sub-frame, whereas the means for detecting is configured to detect a first reference symbol and a second reference symbol within the sub-frame. For this embodiment, the signal is associated with a relay, and the first reference symbol is detected before the second reference symbol. The means for decoding is configured to decode the signal based on the first reference symbol.

In another aspect, methods and computer program products are disclosed for an early processing of relay signals. These embodiments include generating a signal associated with a relay within a sub-frame. A first reference symbol and a second reference symbol are then provided within the sub-frame, such that the first reference symbol is provided before the second reference symbol. These embodiments further include transmitting the signal to the relay, wherein the signal is decodable based on the first reference symbol.

An apparatus for an early processing of relay signals is also disclosed. Within such embodiment, the apparatus includes a processor configured to execute computer executable components stored in memory. The computer executable components include a generation component, a reference component, and a communication component. The generation component is configured to generate a signal within a sub-frame, whereas the reference component is configured to provide a first reference symbol and a second reference symbol within the sub-frame. For this embodiment, the signal is associated with a relay, and the first reference symbol is provided before the second reference symbol. Furthermore, the communication component is configured to transmit the signal to the relay, wherein the signal is decodable based on the first reference symbol.

In a further aspect, another apparatus is disclosed. Within such embodiment, the apparatus includes means for generating, means for providing, and means for transmitting. For this embodiment, the means for generating is configured to generate a signal within a sub-frame, whereas the means for providing is configured to provide a first reference symbol and a second reference symbol within the sub-frame. For this embodiment, the signal is associated with a relay, and the first reference symbol is provided before the second reference symbol. Furthermore, the means for transmitting is configured to transmit the signal to the relay, wherein the signal is decodable based on the first reference symbol.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an exemplary wireless network environment that can be employed in conjunction with the various systems and methods described herein.

FIG. 3 illustrates a sub-frame exhibiting an exemplary Pure Frequency Division Multiplexing (FDM) design in accordance with certain aspects of the present disclosure.

FIG. 4 illustrates a sub-frame exhibiting an exemplary Hybrid FDM+Time Division Multiplexing (TDM) design in accordance with certain aspects of the present disclosure.

FIG. 5 illustrates an exemplary Demodulation Reference Signal (DM-RS) pattern in accordance with certain aspects of the present disclosure.

FIG. 6 illustrates a first exemplary interleaving structure that enables early decoding in a Pure FDM setup in accordance with certain aspects of the present disclosure.

FIG. 7 illustrates a second exemplary interleaving structure that enables early decoding in a Pure FDM setup in accordance with certain aspects of the present disclosure.

FIG. 8 illustrates a third exemplary interleaving structure that enables early decoding in a Pure FDM setup in accordance with certain aspects of the present disclosure.

FIG. 9 illustrates a fourth exemplary interleaving structure that enables early decoding in a Pure FDM setup in accordance with certain aspects of the present disclosure.

FIG. 10 illustrates a fifth exemplary interleaving structure that enables early decoding in a Pure FDM setup in accordance with certain aspects of the present disclosure.

FIG. 11 illustrates a block diagram of an exemplary relay unit that facilitates an early decoding of relays signals in accordance with an aspect of the subject specification.

FIG. 12 is an illustration of an exemplary coupling of electrical components that effectuate an early decoding of relays signals.

FIG. 13 illustrates a flow diagram of an exemplary methodology that facilitates an early decoding of relays signals in accordance with an aspect of the subject specification.

FIG. 14 illustrates a block diagram of an exemplary network entity that facilitates an early decoding of relays signals in accordance with an aspect of the subject specification.

FIG. 15 is an illustration of an exemplary coupling of electrical components that effectuate an early decoding of relays signals.

FIG. 16 illustrates a flow diagram of an exemplary methodology that facilitates an early decoding of relays signals in accordance with an aspect of the subject specification.

FIG. 17 is an illustration of an exemplary communication system implemented in accordance with various aspects including multiple cells.

FIG. 18 is an illustration of an exemplary base station in accordance with various aspects described herein.

FIG. 19 is an illustration of an exemplary wireless terminal implemented in accordance with various aspects described herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

The subject specification is generally directed towards early decoding techniques for relay backhaul links. Embodiments are disclosed for facilitating such early decoding both at the relay node and from the network.

Certain aspects presented herein provide discussions comparing cell-dedicated reference signal (CRS) based decoding versus demodulation reference signal (DM-RS) based decoding of a Relay Physical Downlink Control Channel (R-PDCCH) backhaul control channel for particular relays (e.g., Type I). In certain applications, as described herein, a pure frequency-division multiplexing (FDM) design may be favorable compared to a hybrid FDM plus time-division multiplexing (TDM) solution. For instance, there may be no need to multiplex control and data, which may avoid wasting resources in situations such as uplink heavy traffic where control may need to be sent without data. Also, the agreed DM-RS patterns for Physical Downlink Shared Channel (PDSCH) may be reused for R-PDCCH and Relay Physical Downlink Shared Channel (R-PDSCH). In a hybrid FDM+TDM design, reusing the patterns may lead to performance degradation due to a limited number of reference symbols in the first slot (if early decoding is targeted). Using CRS instead of DM-RS may be challenging due to the loss of CRS symbols in the control region of a Donor eNB (DeNB), which may lead to few usable reference symbols, especially for antenna ports 2 and 3. Furthermore, the power overhead may be acceptable even if the R-PDCCH is transmitted on a single Resource Block (RB).

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA), High Speed Packet Access (HSPA), and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

High speed packet access (HSPA) can include high speed downlink packet access (HSDPA) technology and high speed uplink packet access (HSUPA) or enhanced uplink (EUL) technology and can also include HSPA+technology. HSDPA, HSUPA and HSPA+ are part of the Third Generation Partnership Project (3GPP) specifications Release 5, Release 6, and Release 7, respectively.

High speed downlink packet access (HSDPA) optimizes data transmission from the network to the user equipment (UE). As used herein, transmission from the network to the user equipment UE can be referred to as the “downlink” (DL). Transmission methods can allow data rates of several Mbits/s. High speed downlink packet access (HSDPA) can increase the capacity of mobile radio networks. High speed uplink packet access (HSUPA) can optimize data transmission from the terminal to the network. As used herein, transmissions from the terminal to the network can be referred to as the “uplink” (UL). Uplink data transmission methods can allow data rates of several Mbit/s. HSPA+ provides even further improvements both in the uplink and downlink as specified in Release 7 of the 3GPP specification. High speed packet access (HSPA) methods typically allow for faster interactions between the downlink and the uplink in data services transmitting large volumes of data, for instance Voice over IP (VoIP), videoconferencing and mobile office applications

Fast data transmission protocols such as hybrid automatic repeat request, (HARQ) can be used on the uplink and downlink. Such protocols, such as hybrid automatic repeat request (HARQ), allow a recipient to automatically request retransmission of a packet that might have been received in error.

Various embodiments are described herein in connection with an access terminal An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with access terminal(s) and can also be referred to as an access point, Node B, Evolved Node B (eNodeB), access point base station, or some other terminology.

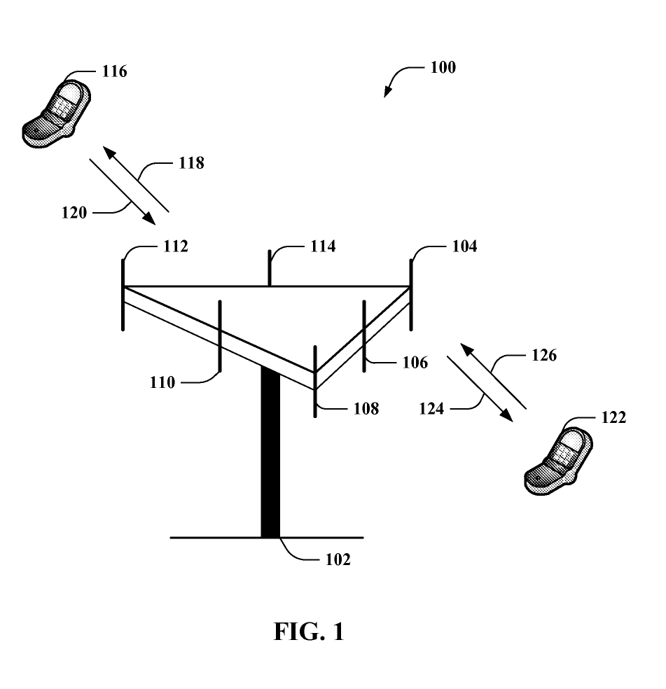

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more access terminals such as access terminal 116 and access terminal 122; however, it is to be appreciated that base station 102 can communicate with substantially any number of access terminals similar to access terminals 116 and 122. Access terminals 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, access terminal 116 is in communication with antennas 112 and 114, where antennas 112 and 114 transmit information to access terminal 116 over a forward link 118 and receive information from access terminal 116 over a reverse link 120. Moreover, access terminal 122 is in communication with antennas 104 and 106, where antennas 104 and 106 transmit information to access terminal 122 over a forward link 124 and receive information from access terminal 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to access terminals in a sector of the areas covered by base station 102. In communication over forward links 118 and 124, the transmitting antennas of base station 102 can utilize beamforming to improve signal-to-noise ratio of forward links 118 and 124 for access terminals 116 and 122. Also, while base station 102 utilizes beamforming to transmit to access terminals 116 and 122 scattered randomly through an associated coverage, access terminals in neighboring cells can be subject to less interference as compared to a base station transmitting through a single antenna to all its access terminals.

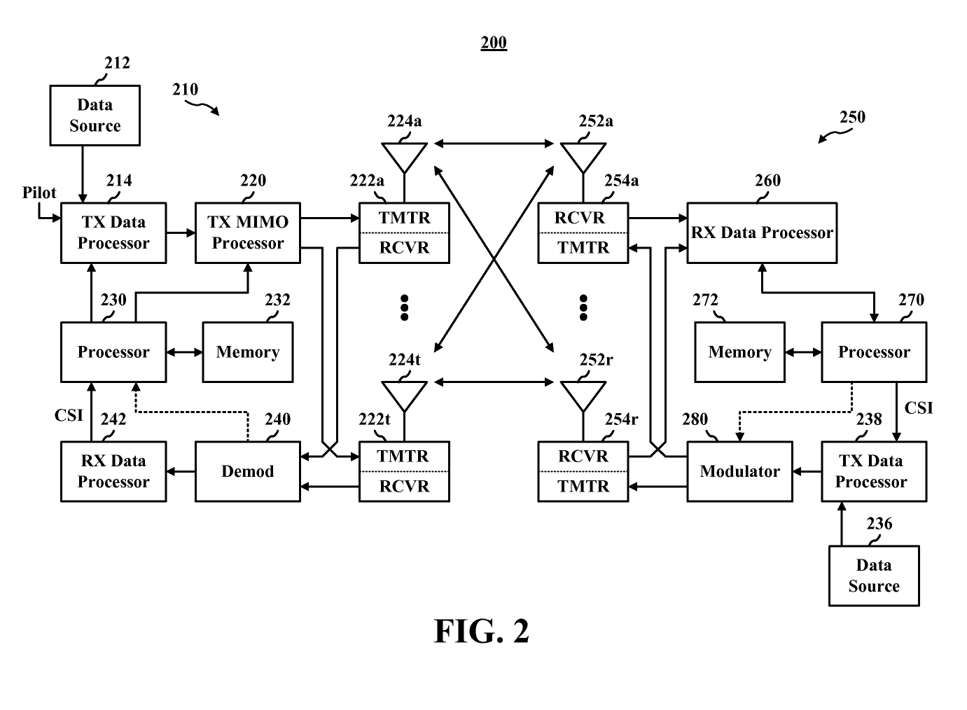

FIG. 2 shows an example wireless communication system 200. The wireless communication system 200 depicts one base station 210 and one access terminal 250 for sake of brevity. However, it is to be appreciated that system 200 can include more than one base station and/or more than one access terminal, wherein additional base stations and/or access terminals can be substantially similar or different from example base station 210 and access terminal 250 described below. In addition, it is to be appreciated that base station 210 and/or access terminal 250 can employ the systems and/or methods described herein to facilitate wireless communication there between.

At base station 210, traffic data for a number of data streams is provided from a data source 212 to a transmit (TX) data processor 214. According to an example, each data stream can be transmitted over a respective antenna. TX data processor 214 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at access terminal 250 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 230.

The modulation symbols for the data streams can be provided to a TX MIMO processor 220, which can further process the modulation symbols (e.g., for OFDM). TX MIMO processor 220 then provides N_{T} modulation symbol streams to N_{T} transmitters (TMTR) 222a through 222t. In various embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 222a through 222t are transmitted from N_{T} antennas 224a through 224t, respectively.

At access terminal 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective signal, digitizes the conditioned signal to provide samples, and further processes the samples to provide a corresponding “received” symbol stream.

An RX data processor 260 can receive and process the N_{R} received symbol streams from N_{R} receivers 254 based on a particular receiver processing technique to provide N_{T} “detected” symbol streams. RX data processor 260 can demodulate, deinterleave, and decode each detected symbol stream to recover the traffic data for the data stream. The processing by RX data processor 260 is complementary to that performed by TX MIMO processor 220 and TX data processor 214 at base station 210.

A processor 270 can periodically determine which available technology to utilize as discussed above. Further, processor 270 can formulate a reverse link message comprising a matrix index portion and a rank value portion.

The reverse link message can comprise various types of information regarding the communication link and/or the received data stream. The reverse link message can be processed by a TX data processor 238, which also receives traffic data for a number of data streams from a data source 236, modulated by a modulator 280, conditioned by transmitters 254a through 254r, and transmitted back to base station 210.

At base station 210, the modulated signals from access terminal 250 are received by antennas 224, conditioned by receivers 222, demodulated by a demodulator 240, and processed by a RX data processor 242 to extract the reverse link message transmitted by access terminal 250. Further, processor 230 can process the extracted message to determine which precoding matrix to use for determining the beamforming weights.

Processors 230 and 270 can direct (e.g., control, coordinate, manage, etc.) operation at base station 210 and access terminal 250, respectively. Respective processors 230 and 270 can be associated with memory 232 and 272 that store program codes and data. Processors 230 and 270 can also perform computations to derive frequency and impulse response estimates for the uplink and downlink, respectively.

CRS BASED VERSUS DM-RS BASED R-PDCCH DECODING

It should be noted that half-duplex relays may not be able to transmit to their associated UEs (e.g., the mobile stations 116 and 122 from FIG. 1) while simultaneously receiving from their DeNB. To address this issue in an LTE-compatible fashion, the relay may be expected to configure its backhaul sub-frames as Multi-Media Broadcast over a Single Frequency Network (MBSFN) sub-frames. However, as a result of the need to configure an MBSFN sub-frame, relays may need up to one OFDM symbol for switching between backhaul and access link operation. Depending on the number of CRS ports configured and the number of control symbols transmitted, the relay may not be able to receive the first OFDM symbol (with one or two CRS ports and one control symbol) or the first two OFDM symbols (with four CRS ports or two control symbols). Moreover, since the relay may not be able to read the DeNB's Physical Control Format Indicator Channel (PCFICH) value, the maximum supported value (i.e., three OFDM symbols for the cases of 3 MHz and beyond) would need to be assumed by the relay. Consequently, according to certain aspects, the R-PDCCH placement may be positioned to start at the fourth OFDM symbol.

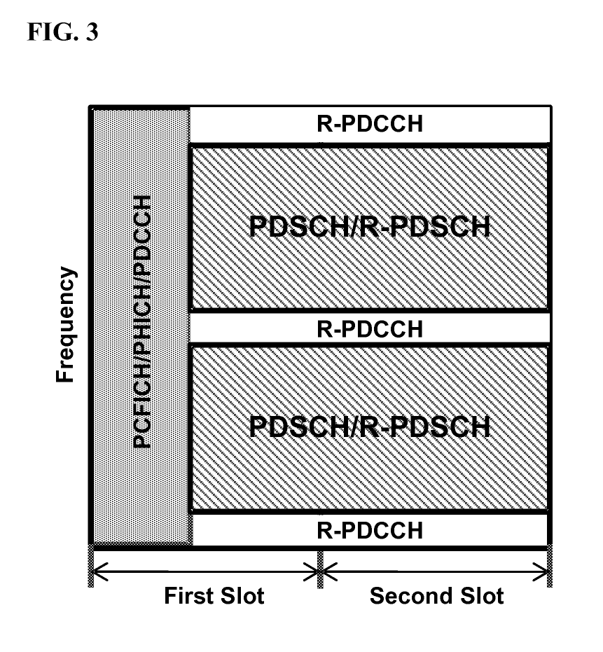

Previous attempts have been focused on two competing approaches for R-PDCCH placement. Namely, a Pure FDM approach as illustrated in FIG. 3, as well as a

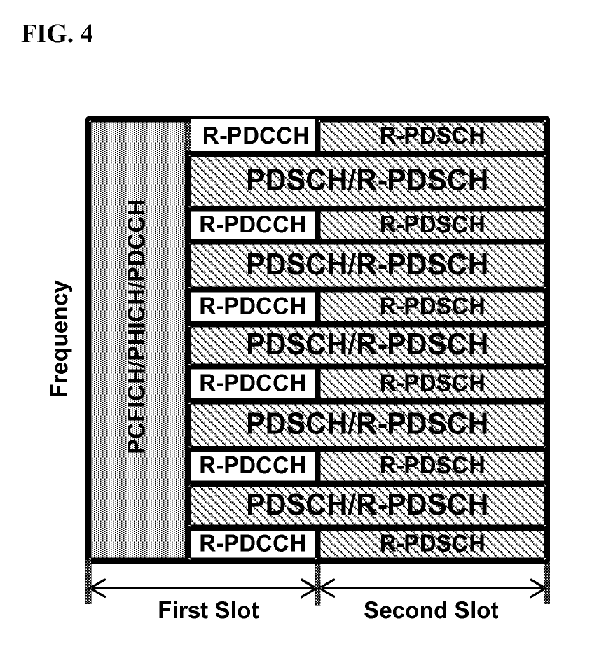

Hybrid FDM+TDM design as illustrated in FIG. 4. The discussion presented herein compares both methods based on their CRS or DM-RS-based decoding performance.

### CRS-Based R-PDCCH Decoding

As a result of the relay operation described above, CRS based decoding of R-PDCCH faces several difficulties. First, CRS may not be available whenever the backhaul transmissions take place on sub-frames that are configured as MBSFN by the DeNB. In order to still enable CRS-based decoding in such a scenario, it may be necessary to transmit CRS at least on those Resource Blocks (RBs) that carry the R-PDCCH. Even then, some benefits typically associated with CRS may not carry over, such as using its wideband nature for improved channel estimation performance.

Furthermore, due to the timing of backhaul transmissions discussed above, the relay may not be able to use the CRS symbols in the DeNB's control region which inevitably results in undesirable decoding performance, especially at medium to high speeds. Also, for antenna ports 2 and 3, the remaining CRS Resource Elements (REs) may be placed on a single OFDM symbol, preventing the relay from interpolating across multiple symbols in time. Moreover, the number of CRS REs per RB available for relay backhaul may be 16, 6, 2, 21 for antenna ports 10, 1, 2, 31, respectively.

A further complication may arise if one attempts to use CRS based decoding for a Hybrid FDM+ TDM setup while targeting early decoding (i.e., starting the R-PDCCH decoding process at the end of the first slot). In this case, even fewer CRS symbols may be available on antenna ports 0 and 1, while there may be none available on antenna ports 2 and 3. Based on this observation, CRS based decoding appears incompatible with early decoding for Hybrid FDM+ TDM setups, unless the R-PDCCH decoding is deferred until the second OFDM symbol of the second slot (i.e., the location of the first CRS symbol in the second slot for antenna ports 2 and 3). However, in this scenario, any potential gain of early decoding may be diminished.

### DM-RS Based R-PDCCH Decoding

According to certain aspects of the present disclosure, for DM-RS based decoding of R-PDCCH, the agreed DM-RS patterns can be readily used by the relay, which mitigates the specification and implementation impact of such decoding. Furthermore, using DM-RS for R-PDCCH decoding may have the additional advantage of supporting beamforming.

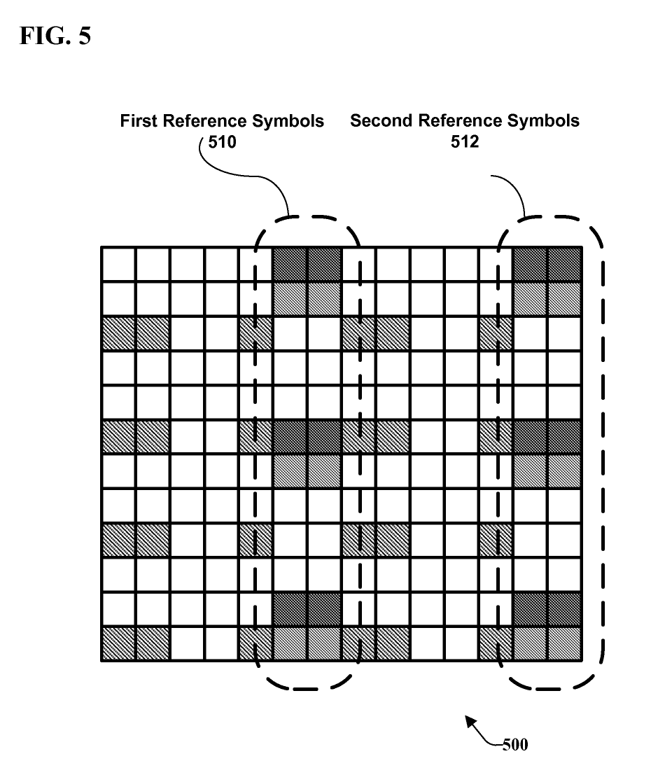

In FIG. 5, an exemplary DM-RS pattern 500 is shown for the normal and extended cyclic prefix (CP) case, wherein first reference symbols 510 and second reference symbols 512 are provided. Based on the earlier relay timing discussion, the relay can use at least eleven symbols following the DeNB's control region of three OFDM symbols. As a result, DM-RS pattern 500 can be used for decoding without requiring any modifications. To this end, it should be noted that FIG. 5 illustrates an exemplary DM-RS pattern for the normal CP case for two antenna ports. Similar patterns may be used for four antenna ports and the extended CP case.

DM-RS-Based Decoding Performance

Link-level performance results for DM-RS based decoding are now discussed for both the Pure FDM design as well as the Hybrid FDM+TDM design. The performance evaluation compares the two setups based on the following assumptions.

For the Pure FDM case, the transmission structure is illustrated in FIG. 3 in which the R-PDCCH is interleaved across a limited number of RBs, typically in the range of 3-4. Decoding may then be performed based on the DM-RS pattern illustrated in FIG. 5.

In the case of hybrid FDM+TDM, as illustrated in FIG. 4, the R-PDCCH is interleaved across a larger number of RBs, but within each only the REs in the first slot may be used to carry the R-PDCCH, while the remaining ones may be used for R-PDSCH transmission. As Hybrid FDM+TDM targets early decoding of R-PDCCH, it may use only the DM-RS symbols transmitted in the first slot for decoding (the DM-RS symbols of the second slot can therefore be dedicated to R-PDSCH decoding). In order to provide a fair comparison, interleaving across a larger number of RBs can be considered compared to Pure FDM as to have a similar control region size for both schemes.

It has been observed that Pure FDM interleaved across three RBs outperforms the Hybrid FDM+TDM interleaved across six RBs (in fact even Pure FDM interleaved across only two RBs has been shown to outperform the Hybrid case albeit by a smaller amount). Specifically, for the case of one Control Channel Element (CCE), if a frame error rate of 10% is targeted, then the gain amounts to 0.8 dB. For an FER target of 1%, the gain amounts to 0.7 dB.

Based at least on these results, it may be concluded that, in some cases, the additional interference diversity achieved by Hybrid FDM+TDM may not be enough to compensate for the degradation of decoding performance that stems from using only the DM-RS symbols in the first slot. In addition to this observation, the Pure FDM may also benefit from dedicating DM-RS symbols to either R-PDCCH or R-PDSCH decoding. In contrast, for the Hybrid FDM+TDM scheme, poorer performance for the R-PDSCH may also be encountered due to the fact that the DM-RS symbols in the first slot may need to support R-PDCCH transmission, and therefore cannot support beamforming tailored to a specific relay. Clearly, this would hurt R-PDSCH decoding performance, and an additional degradation may exist.

### Early Decoding for Pure FDM Multiplexing

Potential early decoding gains of the Hybrid FDM+TDM multiplexing structure could be perceived as a disadvantage of the Pure FDM design. Certain aspects of the present disclosure are directed towards facilitating early decoding in the Pure FDM design by modifying the interleaving and coding structure appropriately.

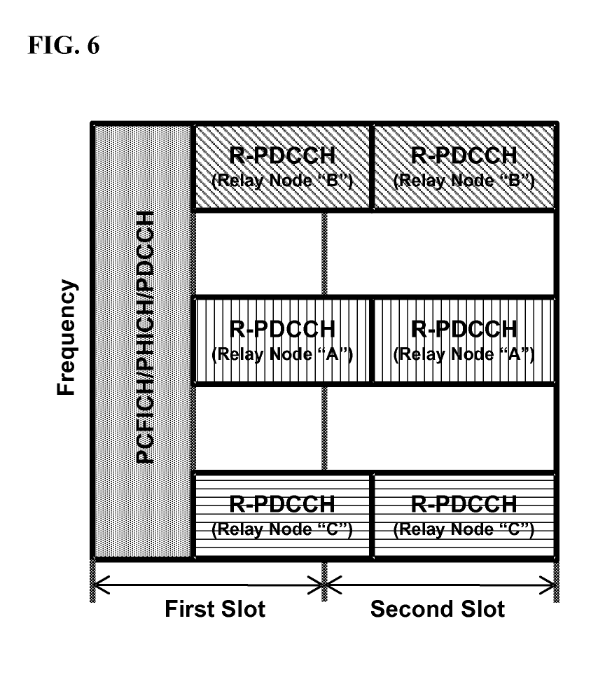

An exemplary embodiment of this concept is illustrated in FIG. 6, in which the R-PDCCH for a certain relay node “A” may be transmitted on the center resources. In this example, the multiplexing structure of Pure FDM with R-PDSCH and PDSCH may remain unaltered although the latter channels are not shown in FIG. 6 for simplicity. As illustrated in FIG. 6, the R-PDCCH intended for relay “A” may not be interleaved across the entire sub-frame, but a smaller region that comprises roughly half of the OFDM symbols (the exact size of this region as well as the interleaving procedure remain to be specified). The interleaved R-PDCCH block for relay “A” may be then repeated to fill up all available resources in the sub-frame.

The above structure enables the Relay Node (RN) “A” to perform early decoding by attempting to decode its R-PDCCH based on the first interleaved block only. If decoding is successful, the relay may terminate the decoding process as it knows that what follows in this specific RB is a repetition of the first interleaved block. However, if decoding is unsuccessful, the relay may engage in a second decoding attempt, leveraging the additional energy contained in the second interleaved block.

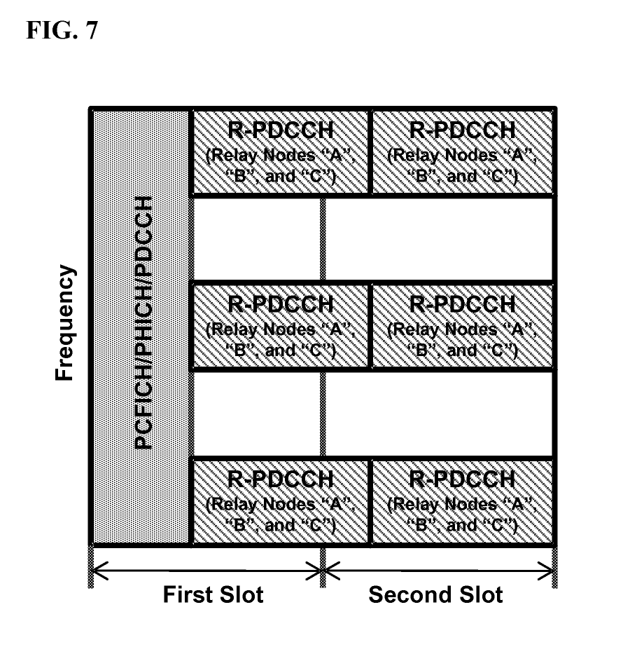

The concept described above can be further refined to improve resource and bandwidth utilization. Specifically, if the RN “A” is able to achieve early decoding most of the time based on the first interleaved block, then resource utilization may be further improved by using the second interleaved block for other relay R-PDCCHs as well. For example, the setup depicted in FIG. 7 can be considered in which the first interleaved block may comprise the interleaved R-PDCCH of three relays, “A,” “B,” and “C.” The relay “A” may target early decoding while relays “B” and “C” may not (both eNodeB and relays may be aware of these decoding objectives through higher layer signaling). As illustrated in FIG. 7, the interleaving structure of both time domain-interleaved blocks may be similar, allowing successive decoding attempts as for the case discussed earlier. However, since only the relay “A” may attempt early decoding, resources in the second half of the RB may be only partially “wasted,” since relays “B” and “C” may rely on them anyway.

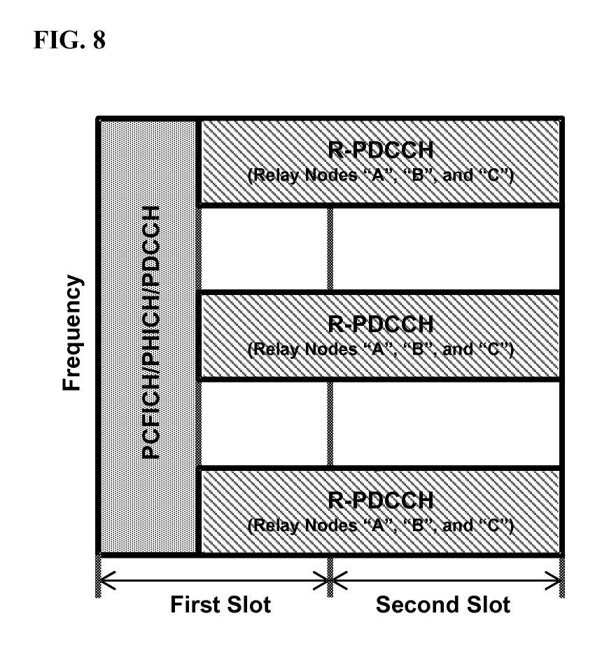

The concept illustrated in FIG. 7 can also be applied without enforcing a strict slot boundary. Specifically, as depicted in FIG. 8, it is possible to bias the resource element group (REG) mapping in such a way that the R-PDCCH for relay “A” may be mostly located in the first half, whereas the R-PDCCHs of relays “B” and “C” may be mostly located in the second time slot. This may again enable the DeNB to favor certain relays by allowing them to decode earlier than others on average.

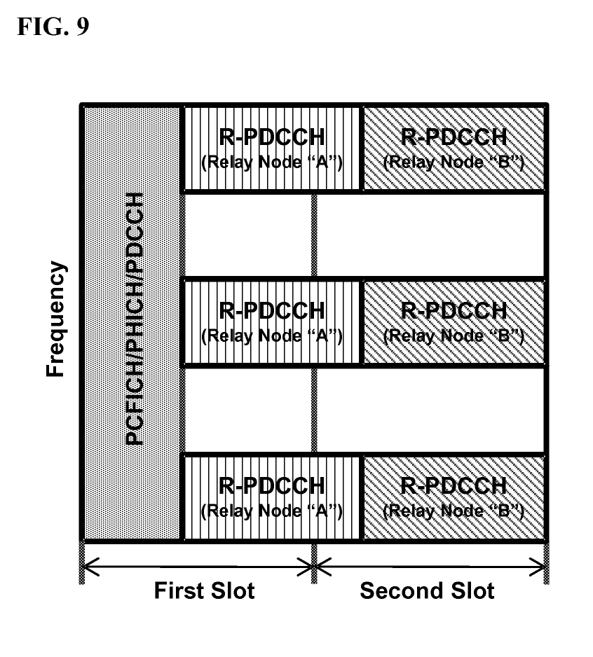

A further embodiment of this concept is illustrated in FIG. 9 in which the interleaved blocks may not have identical structure: the R-PDCCH of the relay “A” may be only interleaved in the first block, whereas the other relay “B” may be interleaved only across the second slot (and therefore may not have the potential for early decoding). It should be noted that such a scenario may be of interest from a practical perspective if relay “A” operates at relatively high rates and possesses good channel conditions compared to relay “B.” In this case, it may be worthwhile to support early decoding for relay “A” but not necessarily for relay “B.” It should be noted that the search space for the R-PDCCH may be such that every relay gets at least one R-PDCCH in the first slot. This may, for example, be done by ensuring a common search space in the first time slot.

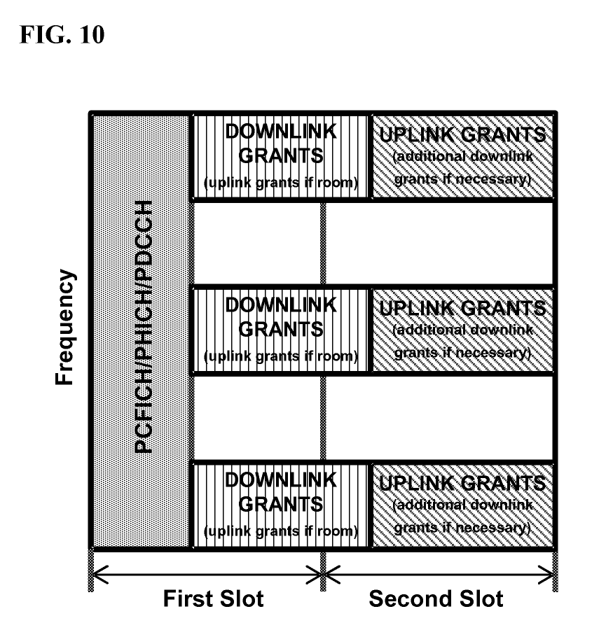

Another alternative illustrated in FIG. 10 may be to prioritize the transmission of downlink (DL) grants over uplink (UL) grants. As illustrated in FIG. 10, the DL grants may be transmitted exclusively in the first time slot (possibly occupying some additional resources in the second time slot, if required), while the UL grants may use the remaining resources and may be therefore mostly transmitted in the second time slot. An advantage of this configuration is that the UL grants may typically require less processing time and therefore some early decoding gains may be achieved using this technique.

It should also be noted that the interleaved blocks depicted in FIGS. 6-10 may not need to coincide with the slot boundary of the RB. Rather, a tradeoff may need to be struck between sacrificing early decoding gain by increasing the length of the first block and maintaining a high probability for the relay to successfully decode based on the first interleaved block most of the time.

Exemplary operations are now provided that may be executed at a DeNB for generating an interpolating control structure transmitted over control channels to enable early decoding. Such operations may begin with the generation of a control structure comprising R-PDCCH blocks with reference signals dedicated to a plurality of relay nodes. Here, it should be noted that the R-PDCCH blocks may occupy a plurality of frequency resources and at least two time slots, wherein each R-PDCCH block may occupy a portion of the time slot. Next, the DeNB may transmit the control structure to the plurality of relay nodes using the frequency resources and the time slots.

Exemplary operations are now provided which may facilitate early decoding of control channels of relay backhaul links at a relay node. For instance, such operations may begin with the relay node receiving a control structure transmitted over frequency resources and time slots comprising R-PDCCH blocks with reference signals dedicated to a plurality of relay nodes. Within such embodiment, the R-PDCCH blocks may occupy the frequency resources and at least two of the time slots, wherein each R-PDCCH block may occupy a portion of the time slot. The relay node may then decode at least one of the R-PDCCH blocks.

Yet another potential way of supporting early decoding is to perform the REG mapping in a frequency-first (instead of time-first) fashion. Depending on the interleaving structure performed by the eNB, some relays may statistically benefit from early decoding. Alternately, with time-first encoding or a combination of time-first interleaving with frequency-first interleaving, the relay may only use the modulation symbols in the first slot to decode. The donor eNB may increase the power of the R-PDCCH, or use a higher CCE R-PDCCH to enable early decoding by the relay. Additionally, it may be also possible to use different pre-coding vectors for different slots, or to apply different power boosts for the DM-RS.

It may also be noted that while the interleaving structure described in this section may appear to resemble the Hybrid FDM+TDM setup, the design solely operates on the R-PDCCHs of different relays as opposed to both R-PDCCH and R-PDSCH. The multiplexing of control and data continues to be avoided in this Pure FDM setup and, as a result, the benefits of Pure FDM described earlier may continue to apply.

Certain aspects of the present disclosure provide techniques for intelligent R-PDCCH resource/power/aggregation level choices at the eNB, which may also help enable such early decoding. In addition to choosing resource, power, and aggregation levels with the objective of enabling early decoding, this may include but is not limited to using different pre-coding vectors for different slots or using power boosting for the R-PDCCH data tones for different slots, but not for the DM-RS.

Furthermore, the above techniques that enable early decoding for R-PDCCH may also be extended to R-PDSCH, facilitating early decoding of data by the relay, which is especially beneficial for relays that are being served at high rates. For example, a frequency domain-first mapping, or the repetition-type mapping of two “soft” slots can be used to enable such rate matching for R-PDSCH.

Placement of R-PHICH Blocks

In certain aspects of the present disclosure, R-PHICH (Relay Physical Hybrid ARQ (Automatic Repeat Request) Indicator Channel) blocks may be transmitted together with the R-PDCCH blocks. A relay node may then receive and decode one or more of the R-PHICH blocks along with the reception and decoding of the R-PDCCH blocks. The R-PHICH transmission may be accommodated on a subset of those resource blocks (RBs) that are already dedicated to the R-PDCCH. Certain aspects of the present disclosure may support different transmit configurations with regard to the R-PHICH placement in time. In the following, different options for the R-PHICH placement will be discussed based on the R-PDCCH configuration illustrated in FIG. 10, but some of the key concepts may also be applicable in other configurations.

According to the LTE Release-8 specifications, the PHICH (Physical Hybrid ARQ Indicator Channel) may comprise twelve Resource Elements (REs) in the case of normal CP configuration. These REs may be transmitted in a set of three groups of four REs in each group and interleaved across the system bandwidth. In the relay context, the R-PHICH may comprise the same number of resource elements transmitted on a subset of the RBs dedicated for the R-PDCCH.

In the time domain, the R-PHICH resources may be mapped exclusively to the portion of the sub-frame that carries DL or UL grants, respectively (e.g., the DL and UL grants illustrated in FIG. 10). Transmitting the R-PHICH in the UL portion may be the preferred option given that the R-PHICH may carry uplink-relevant information. However, it may also be possible to utilize both DL and UL portions of the sub-frame for R-PHICH transmission, but without having individual R-PHICH groups crossing a boundary between DL and UL portion of the sub-frame. In yet another R-PHICH configuration, such an overlap may be allowed but it should be noted that such a configuration may need to be carefully designed as DL and UL portions of the sub-frame may be subject to different interleaving procedures.

According to certain aspects, it is proposed herein that the UE-RS pattern for normal sub-frames may be adopted as the DM-RS pattern for R-PDCCH and that the R-PDCCH may start from the fourth OFDM symbol for the case of bandwidths beyond lORBs. The Pure FDM and Hybrid FDM+TDM concepts were compared based on link-level simulations, which showed that Pure FDM outperforms the hybrid scheme, even when restricted to interleave across a limited number of RBs. Based on these findings, according to certain aspects, a Pure FDM design may be adopted for R-PDCCH. Furthermore, potential approaches to support early decoding within a Pure FDM design, as discussed above, may also be utilized.

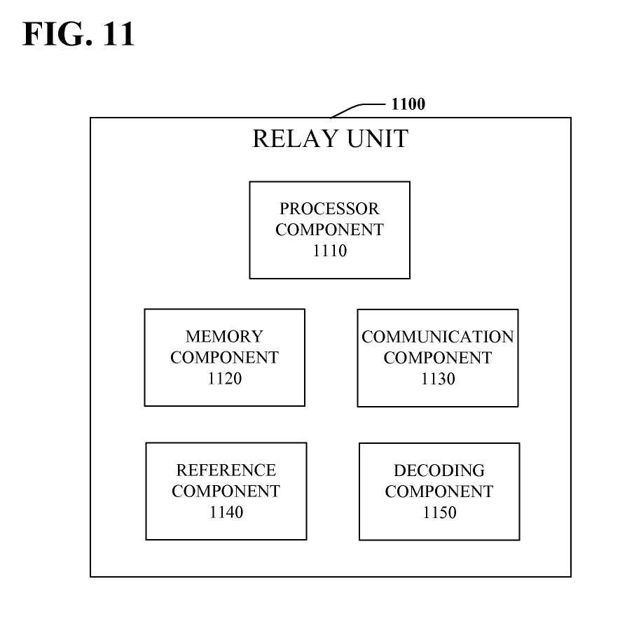

Referring next to FIG. 11, a block diagram of an exemplary relay unit that facilitates an early decoding of relay signals according to an embodiment is provided. As shown, relay unit 1100 may include processor component 1110, memory component 1120, communication component 1130, reference component 1140, and decoding component 1150.

In one aspect, processor component 1110 is configured to execute computer-readable instructions related to performing any of a plurality of functions. Processor component 1110 can be a single processor or a plurality of processors dedicated to analyzing information to be communicated from relay unit 1100 and/or generating information that can be utilized by memory component 1120, communication component 1130, reference component 1140, and/or decoding component 1150. Additionally or alternatively, processor component 1110 may be configured to control one or more components of relay unit 1100.

In another aspect, memory component 1120 is coupled to processor component 1110 and configured to store computer-readable instructions executed by processor component 1110. Memory component 1120 may also be configured to store any of a plurality of other types of data including generated by any of communication component 1130, reference component 1140, and/or decoding component 1150. Memory component 1120 can be configured in a number of different configurations, including as random access memory, battery-backed memory, hard disk, magnetic tape, etc. Various features can also be implemented upon memory component 1120, such as compression and automatic back up (e.g., use of a Redundant Array of Independent Drives configuration).

In yet another aspect, relay unit 1100 includes communication component 1130, which is coupled to processor component 1110 and configured to interface relay unit 1100 with external entities. For instance, communication component 1130 may be configured to receive a signal within a sub-frame, wherein the received signal is associated with relay unit 1100. Here, it is contemplated that sub-frames which include the received signal can be designed according to any of a plurality of architectures. For instance, the sub-frame may be a hybrid sub-frame which includes both frequency division multiplexing and time division multiplexing. In another embodiment, however, the sub-frame is a pure frequency division multiplexing sub-frame.

In an aspect, it should be noted that the received signal may be included in a Relay Physical Downlink Control Channel (R-PDCCH). Within such embodiment, the received signal may be included in a plurality of signals respectively corresponding to different relays, wherein the R-PDCCH includes the plurality of signals. In another aspect, the received signal may be included in a Relay Physical Downlink Shared Channel. For this particular embodiment, the received signal may be included in a plurality of signals respectively corresponding to different relays, wherein the R-PDCCH includes the plurality of signals.

As illustrated, relay unit 1100 may further include reference component 1140. Within such embodiment, reference component 1140 is configured to detect a first reference symbol and a second reference symbol within the sub-frame. Here, it should be noted that the first reference symbol is detected before the second reference symbol. It should be further noted that, although any of various types of reference signals may be detected, particular embodiments are contemplated in which the first reference symbol and the second reference symbol are associated with a demodulation reference signal.

In an aspect, relay unit 1100 further includes decoding component 1150. Within such embodiment, decoding component 1150 is configured to decode the received relay signal based on the first reference symbol. In a particular embodiment, decoding component 1150 is further configured to identify a unique parameter associated with the received signal, wherein the unique parameter is at least one of a power level, a resource level, or an aggregation level. In another embodiment, decoding component 1150 is configured to distinguish different pre-coding vectors respectively associated with different slots within the sub-frame. In yet another embodiment, decoding component 1150 is configured to identify a power boost applied to data tones associated with the received signal, wherein the first reference symbol and the second reference symbol are excluded from the power boost.

It is contemplated that relay unit 1100 may sometimes fail to decode the received signal with the first reference symbol. To this end, an embodiment is provided in which the signal associated with relay unit 1100 is included in a first portion of a resource block, wherein the signal is then repeated in a second portion of the resource block received after the first portion. Within such embodiment, decoding component 1150 may be configured to attempt to decode the signal via the first portion of the resource block, wherein decoding component 1150 is further configured to perform a subsequent decoding of the signal via the second portion of the resource block if the signal is unsuccessfully decoded via the first portion.

It is further contemplated that the relay signal associated with relay unit 1100 may be included within a plurality of signals. For instance, a plurality of signals respectively corresponding to a plurality of relays may be included in a single resource block. In an aspect, as illustrated in FIG. 7, the plurality of signals may be included in a first portion of the resource block, wherein the plurality of signals are repeated in a second portion of the resource block received after the first portion. In another aspect, as illustrated in FIG. 8, a signal associated with a particular relay may be biased towards a first portion of the resource block, wherein a remainder of the plurality of signals is biased towards a second portion received after the first portion. In yet another aspect, as illustrated in FIG. 9, a signal associated with a particular relay may be included in a first portion of the resource block, wherein a different signal associated with a different relay may be included in a second portion received after the first portion.

Embodiments directed towards communicating uplink and downlink grants are also disclosed. For instance, in an aspect, the received relay signal includes a set of uplink grants and a set of downlink grants. Within such embodiment, the set of downlink grants are included in a first portion of a resource block, whereas the set of uplink grants are included in a second portion of the resource block received after the first portion.

In a further aspect, it is contemplated that communication component 1130 may be configured to receive non-control channels via resource blocks dedicated to control channels. For instance, in a particular embodiment communication component 1130 is configured to receive a Relay Physical Hybrid Automatic Repeat Request Indicator Channel in a resource block dedicated to R-PDCCH. For this embodiment, decoding component 1150 may be configured to map resources associated with the Relay Physical Hybrid Automatic Repeat Request Indicator Channel exclusively to a portion of the sub-frame that includes at least one of a set of uplink grants or a set of downlink grants.

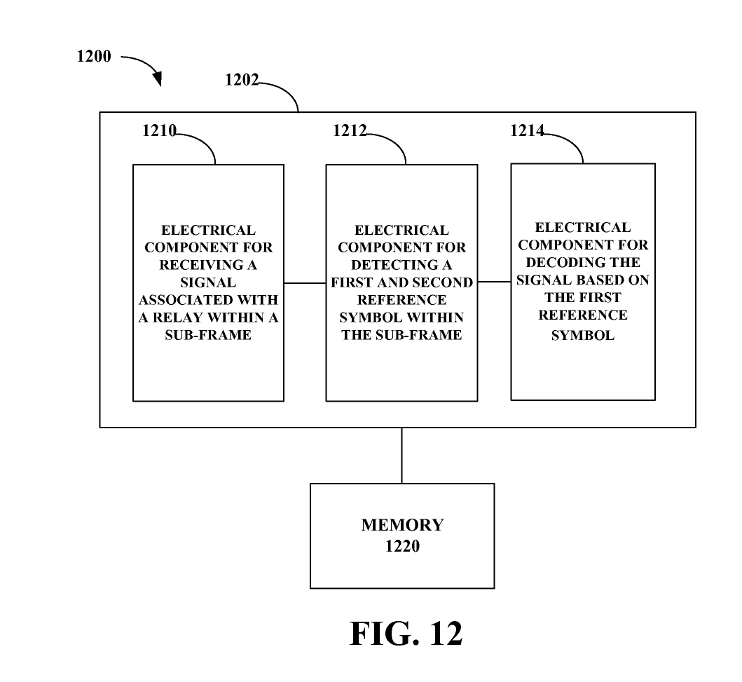

Turning to FIG. 12, illustrated is a system 1200 that facilitates an early decoding of relay signals according to an embodiment. System 1200 and/or instructions for implementing system 1200 can reside within a relay node (e.g., relay unit 1100) or a computer-readable storage medium, for instance. As depicted, system 1200 includes functional blocks that can represent functions implemented by a processor, software, or combination thereof (e.g., firmware). System 1200 includes a logical grouping 1202 of electrical components that can act in conjunction. As illustrated, logical grouping 1202 can include an electrical component for receiving a signal associated with a relay within a sub-frame 1210. Logical grouping 1202 can also include an electrical component for detecting a first and second reference symbol within the sub-frame 1212. Further, logical grouping 1202 can include an electrical component for decoding the signal based on the first reference symbol 1214. Additionally, system 1200 can include a memory 1220 that retains instructions for executing functions associated with electrical components 1210, 1212, or 1214, wherein any of electrical components 1210, 1212, or 1214 can exist either within or outside memory 1220.

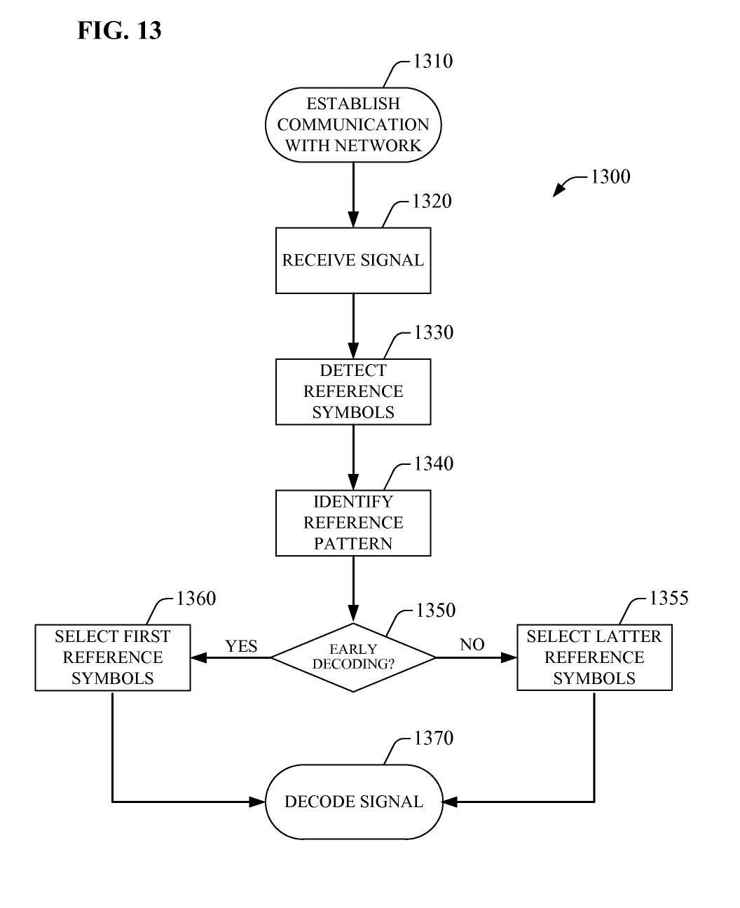

Referring next to FIG. 13, a flow chart illustrating an exemplary method for facilitating an early decoding of relay signals is provided. As illustrated, process 1300 includes a series of acts that may be performed by various components of a relay node (e.g., relay unit 1100) according to an aspect of the subject specification. Process 1300 may be implemented by employing at least one processor to execute computer executable instructions stored on a computer readable storage medium to implement the series of acts. In another embodiment, a computer-readable storage medium comprising code for causing at least one computer to implement the acts of process 1300 are contemplated.

In an aspect, process 1300 begins with a communication being established with a network at act 1310. Next, at act 1320, a relay signal is received from the network, followed by a detection of reference symbols within the signal at act 1330. Here, it should be noted that any of a plurality of reference signals can be received including, for example, demodulation reference signals. To this end, once the reference symbols have been detected, process 1300 proceeds by identifying a particular reference symbol pattern at act 1340. For instance, in an aspect, the pattern illustrated in FIG. 5 may be identified, wherein at least a first and second set of reference symbols are received, as shown.

It is contemplated that, for some relay nodes, early decoding may not be necessary and/or desired. Accordingly, at act 1350, process 1300 determines whether to apply an early decoding algorithm. If early decoding is desired, process 1300 proceeds to act 1360 where a first set of reference symbols are selected to facilitate a subsequent decoding at act 1370. Otherwise, if early decoding is not desired, process 1300 proceeds to act 1355 where a latter set of reference symbols are selected to facilitate the decoding performed at act 1370.

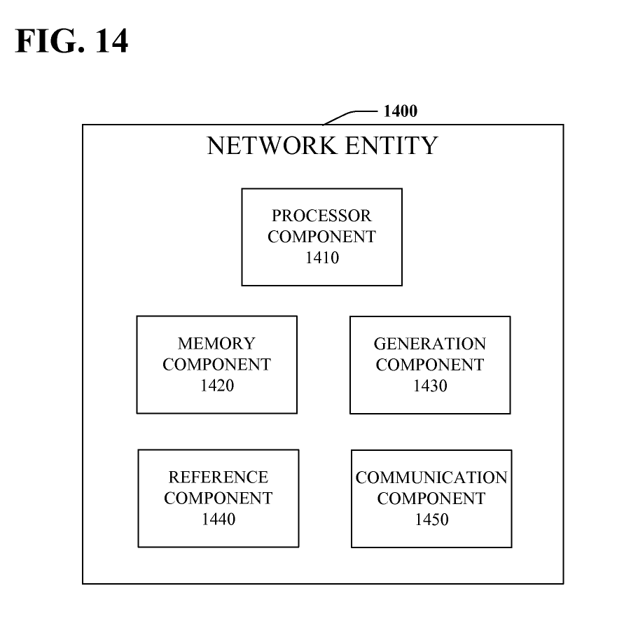

Referring next to FIG. 14, a block diagram illustrates an exemplary network entity (e.g., an eNodeB) that facilitates an early decoding of relay signals in accordance with various aspects. As illustrated, network entity 1400 may include processor component 1410, memory component 1420, generation component 1430, reference component 1440, and communication component 1450.

Similar to processor component 1110 in relay unit 1100, processor component 1410 is configured to execute computer-readable instructions related to performing any of a plurality of functions. Processor component 1410 can be a single processor or a plurality of processors dedicated to analyzing information to be communicated from network entity 1400 and/or generating information that can be utilized by memory component 1420, generation component 1430, reference component 1440, and/or communication component 1450. Additionally or alternatively, processor component 910 may be configured to control one or more components of network entity 1400.

In another aspect, memory component 1420 is coupled to processor component 1410 and configured to store computer-readable instructions executed by processor component 1410. Memory component 1420 may also be configured to store any of a plurality of other types of data including data generated by any of generation component 1430, reference component 1440, and/or communication component 1450. Here, it should be noted that memory component 1420 is analogous to memory component 1120 in relay unit 1100. Accordingly, it should be appreciated that any of the aforementioned features/configurations of memory component 1120 are also applicable to memory component 1420.

As illustrated, network entity 1400 may also include generation component 1430. Within such embodiment, generation component 1430 may be configured to generate a relay signal within a particular sub-frame. Here, it is contemplated that sub-frames which include the generated signal can be designed according to any of a plurality of architectures. For instance, in a first embodiment, the sub-frame may be a hybrid sub-frame which includes both frequency division multiplexing and time division multiplexing whereas, in another embodiment, the sub-frame may be a pure frequency division multiplexing sub-frame. In a further embodiment, generation component 1430 is configured to associate a unique parameter with the generated signal, wherein the unique parameter is at least one of a power level, a resource level, or an aggregation level. In yet another embodiment, generation component 1430 is configured to utilize different pre-coding vectors respectively associated with different slots within the sub-frame.

Network entity 1400 may also include reference component 1440. Within such embodiment, reference component 1440 is configured to provide a first reference symbol and a second reference symbol within the sub-frame. Here, it should be noted that the first reference symbol is provided before the second reference symbol. It should be further noted that, although any of various types of reference signals may be provided, particular embodiments are contemplated in which the first reference symbol and the second reference symbol are associated with a demodulation reference signal.

In another aspect, network entity 1400 includes communication component 1450, which is coupled to processor component 1410 and configured to interface network entity 1400 with external entities. For instance, communication component 1450 may be configured to transmit the generated signals to the appropriate relays, wherein such signals are decodable based on the first reference symbol. In a particular embodiment, communication component 1450 is configured to apply a power boost to data tones associated with the generated signal. Within such embodiment, communication component 1450 may be further configured to exclude the first reference symbol and the second reference symbol from the power boost.

In a further aspect, it is contemplated that communication component 1450 may be configured to communicate relay signals via control channels and/or non-control channels. For instance, communication component 1450 may be configured to include generated relay signals in R-PDCCH. Within such embodiment, a generated signal may be included in a plurality of signals respectively corresponding to different relays, wherein the R-PDCCH includes the plurality of signals. In another aspect, communication component 1450 may be configured to include generated relay signals in a Relay Physical Downlink Shared Channel. For this particular embodiment, a generated signal may be included in a plurality of signals respectively corresponding to different relays, wherein the R-PDCCH includes the plurality of signals.

As stated previously with respect to relay unit 1100, it is contemplated that relay nodes will sometimes fail to decode relay signals with the first reference symbol. To this end, an embodiment is provided in which generation component 1430 is configured to include the generated signal in a first portion of a resource block, wherein generation component 1430 is then further configured to repeat the signal in a second portion of the resource block transmitted after the first portion. Within such embodiment, relay nodes may attempt to perform an early decoding via the first portion of the resource block, wherein a subsequent attempt to decode the relay signal is performed via the second portion of the resource block if the early decoding attempt failed.

It is further contemplated that relay signals may be included within a plurality of signals. For instance, a plurality of signals respectively corresponding to a plurality of relays may be included in a single resource block. In an aspect, as illustrated in FIG. 7, generation component 1430 may be configured to include the plurality of signals in a first portion of the resource block, wherein generation component 1430 is further configured to repeat the plurality of signals in a second portion of the resource block transmitted after the first portion. In another aspect, as illustrated in FIG. 8, generation component 1430 may be configured to bias the signal towards a first portion of the resource block, wherein a remainder of the plurality of signals is biased towards a second portion of the resource block transmitted after the first portion. In yet another aspect, as illustrated in FIG. 9, generation component 1430 may be configured to include the signal in a first portion of the resource block, wherein a different signal associated with a different relay is included in a second portion of the resource block transmitted after the first portion.

It should be further noted that network entity 1400 may also facilitate communicating uplink and downlink grants. For instance, in an aspect, generation component 1430 is configured to generate relay signals that include a set of uplink grants and a set of downlink grants. Within such embodiment, generation component 1430 may be configured to include the set of downlink grants in a first portion of a resource block, whereas the set of uplink grants are included in a second portion of the resource block transmitted after the first portion.

In a further aspect, it is contemplated that relay nodes may be configured to receive non-control channels via resource blocks dedicated to control channels. To this end, in a particular embodiment generation component 1430 is configured to include a Relay Physical Hybrid Automatic Repeat Request Indicator Channel in a resource block dedicated to R-PDCCH. Within such embodiment, generation component 1430 may be configured to map resources associated with the Relay Physical Hybrid Automatic Repeat Request Indicator Channel exclusively to a portion of the sub-frame that includes at least one of a set of uplink grants or a set of downlink grants.

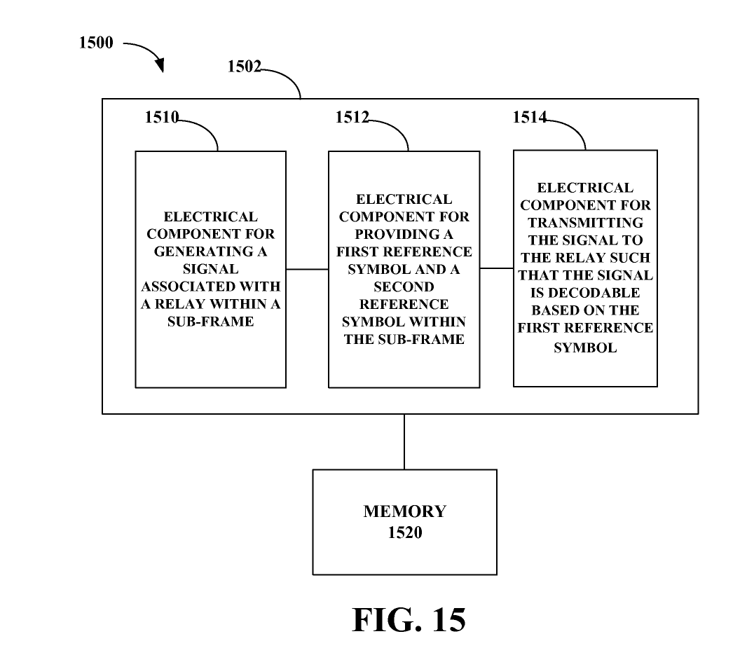

Referring next to FIG. 15, illustrated is a system 1500 that facilitates an early decoding of relay signals according to an embodiment. System 1500 and/or instructions for implementing system 1500 can reside within a network entity (e.g., base station 1400) or a computer-readable storage medium, for instance, wherein system 1500 includes functional blocks that can represent functions implemented by a processor, software, or combination thereof (e.g., firmware). Moreover, system 1500 includes a logical grouping 1502 of electrical components that can act in conjunction similar to logical grouping 1202 in system 1200. As illustrated, logical grouping 1502 can include an electrical component for generating a signal associated with a relay within a sub-frame 1510. Logical grouping 1502 can also include an electrical component for providing a first reference symbol and a second reference symbol within the sub-frame 1512. Further, logical grouping 1502 can include an electrical component for transmitting the signal to the relay such that the signal is decodable based on the first reference symbol 1514. Additionally, system 1500 can include a memory 1520 that retains instructions for executing functions associated with electrical components 1510, 1512, or 1514, wherein any of electrical components 1510, 1512, or 1514 can exist either within or outside memory 1520.

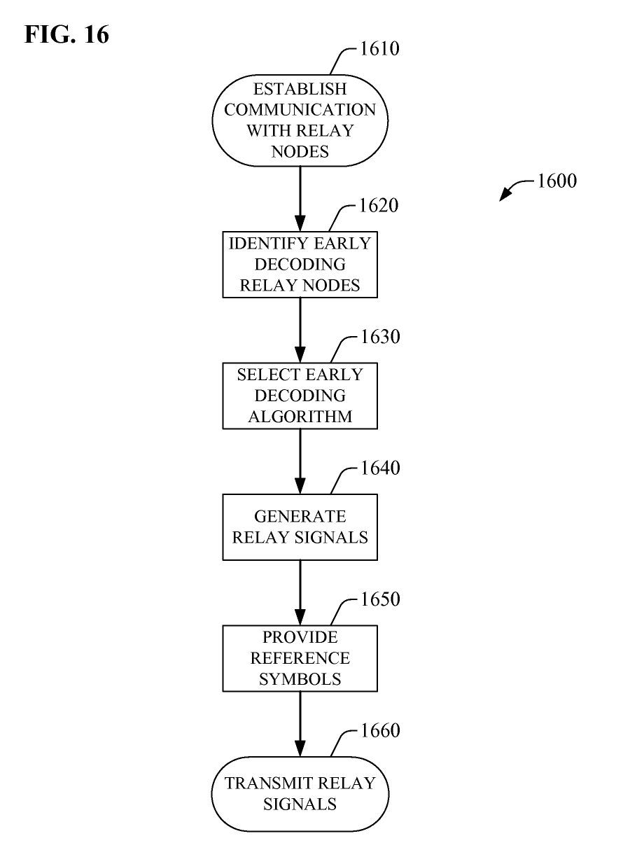

Referring next to FIG. 16, a flow chart illustrating an exemplary method for facilitating an early decoding of relay signals is provided. As illustrated, process 1600 includes a series of acts that may be performed by various components of a network (e.g., network entity 1400) according to an aspect of the subject specification. Process 1600 may be implemented by employing at least one processor to execute computer executable instructions stored on a computer readable storage medium to implement the series of acts. In another embodiment, a computer-readable storage medium comprising code for causing at least one computer to implement the acts of process 1600 are contemplated.

In an aspect, process 1600 begins with a communication being established with a plurality of relay nodes at act 1610. Next, at act 1620, proceeds by identifying which of the plurality of relay nodes are desired for early decoding, followed by the selection of an appropriate early decoding algorithm at act 1630. To this end, it should be noted that any of various early decoding algorithms may be implemented including, but not limited to, the various early decoding algorithms disclosed herein.

Once the appropriate early decoding algorithm has been selected, process 1600 continues to act 1640 where relay signals are generated according to the selected early decoding algorithm. At act 1650, reference symbols are then provided in the generated signals, which may include utilizing any of various reference signals. For example, as stated previously, demodulation reference signals may be used. Once the reference symbols have been included in the relay signals, process 1600 concludes with the relay signals being transmitted to the appropriate relay nodes at act 1660.

### Exemplary Communication System

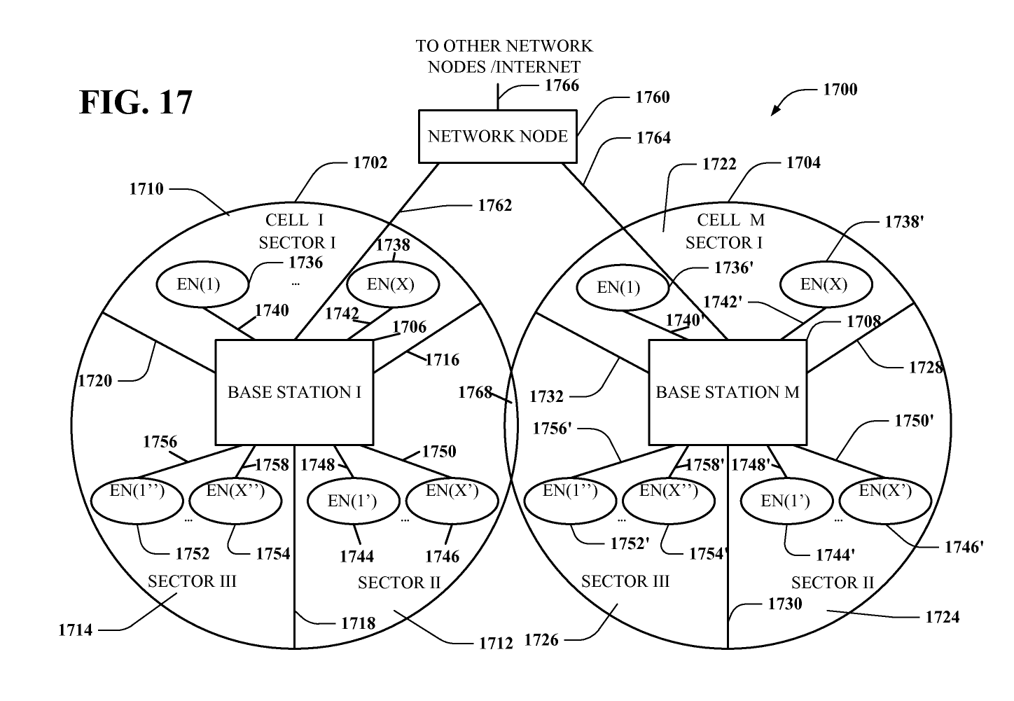

Referring next to FIG. 17, an exemplary communication system 1700 implemented in accordance with various aspects is provided including multiple cells: cell I 1702, cell M 1704. Here, it should be noted that neighboring cells 1702, 1704 overlap slightly, as indicated by cell boundary region 1768, thereby creating potential for signal interference between signals transmitted by base stations in neighboring cells. Each cell 1702, 1704 of system 1700 includes three sectors. Cells which have not been subdivided into multiple sectors (N=1), cells with two sectors (N=2) and cells with more than 3 sectors (N>3) are also possible in accordance with various aspects. Cell 1702 includes a first sector, sector I 1710, a second sector, sector II 1712, and a third sector, sector III 1714. Each sector 1710, 1712, and 1714 has two sector boundary regions; each boundary region is shared between two adjacent sectors.

Sector boundary regions provide potential for signal interference between signals transmitted by base stations in neighboring sectors. Line 1716 represents a sector boundary region between sector I 1710 and sector II 1712; line 1718 represents a sector boundary region between sector II 1712 and sector III 1714; line 1720 represents a sector boundary region between sector III 1714 and sector 1 1710. Similarly, cell M 1704 includes a first sector, sector I 1722, a second sector, sector II 1724, and a third sector, sector III 1726. Line 1728 represents a sector boundary region between sector I 1722 and sector II 1724; line 1730 represents a sector boundary region between sector II 1724 and sector III 1726; line 1732 represents a boundary region between sector III 1726 and sector I 1722. Cell I 1702 includes a base station (BS), base station I 1706, and a plurality of end nodes (ENs) in each sector 1710, 1712, 1714. Sector I 1710 includes EN(1) 1736 and EN(X) 1738 coupled to BS 1706 via wireless links 1740, 1742, respectively; sector II 1712 includes EN(1′) 1744 and EN(X′) 1746 coupled to BS 1706 via wireless links 1748, 1750, respectively; sector III 1714 includes EN(1″) 1752 and EN(X″) 1754 coupled to BS 1706 via wireless links 1756, 1758, respectively. Similarly, cell M 1704 includes base station M 1708, and a plurality of end nodes (ENs) in each sector 1722, 1724, and 1726. Sector I 1722 includes EN(1) 1736′ and EN(X) 1738′ coupled to BS M 1708 via wireless links 1740′, 1742′, respectively; sector II 1724 includes EN(1′) 1744′ and EN(X′) 1746′ coupled to BS M 1708 via wireless links 1748′, 1750′, respectively; sector 3 1726 includes EN(1″) 1752′ and EN(X″) 1754′ coupled to BS 1708 via wireless links 1756′, 1758′, respectively.

System 1700 also includes a network node 1760 which is coupled to BS I 1706 and BS M 1708 via network links 1762, 1764, respectively. Network node 1760 is also coupled to other network nodes, e.g., other base stations, AAA server nodes, intermediate nodes, routers, etc. and the Internet via network link 1766. Network links 1762, 1764, 1766 may be, e.g., fiber optic cables. Each end node, e.g. EN 1 1736 may be a wireless terminal including a transmitter as well as a receiver. The wireless terminals, e.g., EN(1) 1736 may move through system 1700 and may communicate via wireless links with the base station in the cell in which the EN is currently located. The wireless terminals, (WTs), e.g. EN(1) 1736, may communicate with peer nodes, e.g., other WTs in system 1700 or outside system 1700 via a base station, e.g. BS 1706, and/or network node 1760. WTs, e.g., EN(1) 1736 may be mobile communications devices such as cell phones, personal data assistants with wireless modems, etc. Respective base stations perform tone subset allocation using a different method for the strip-symbol periods, from the method employed for allocating tones and determining tone hopping in the rest symbol periods, e.g., non strip-symbol periods. The wireless terminals use the tone subset allocation method along with information received from the base station, e.g., base station slope ID, sector ID information, to determine tones that they can employ to receive data and information at specific strip-symbol periods. The tone subset allocation sequence is constructed, in accordance with various aspects to spread inter-sector and inter-cell interference across respective tones. Although the subject system was described primarily within the context of cellular mode, it is to be appreciated that a plurality of modes may be available and employable in accordance with aspects described herein.

### Exemplary Base Station

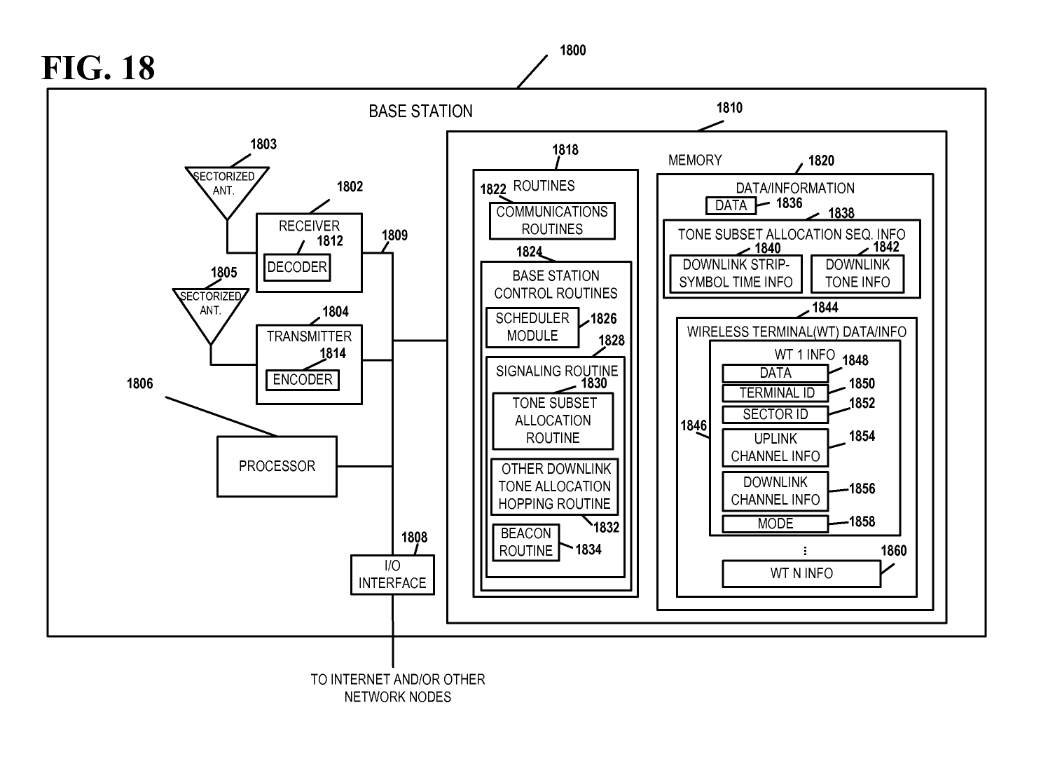

FIG. 18 illustrates an example base station 1800 in accordance with various aspects. Base station 1800 implements tone subset allocation sequences, with different tone subset allocation sequences generated for respective different sector types of the cell. Base station 1800 may be used as any one of base stations 1706, 1708 of the system 1700 of FIG. 17. The base station 1800 includes a receiver 1802, a transmitter 1804, a processor 1806, e.g., CPU, an input/output interface 1808 and memory 1810 coupled together by a bus 1809 over which various elements 1802, 1804, 1806, 1808, and 1810 may interchange data and information.

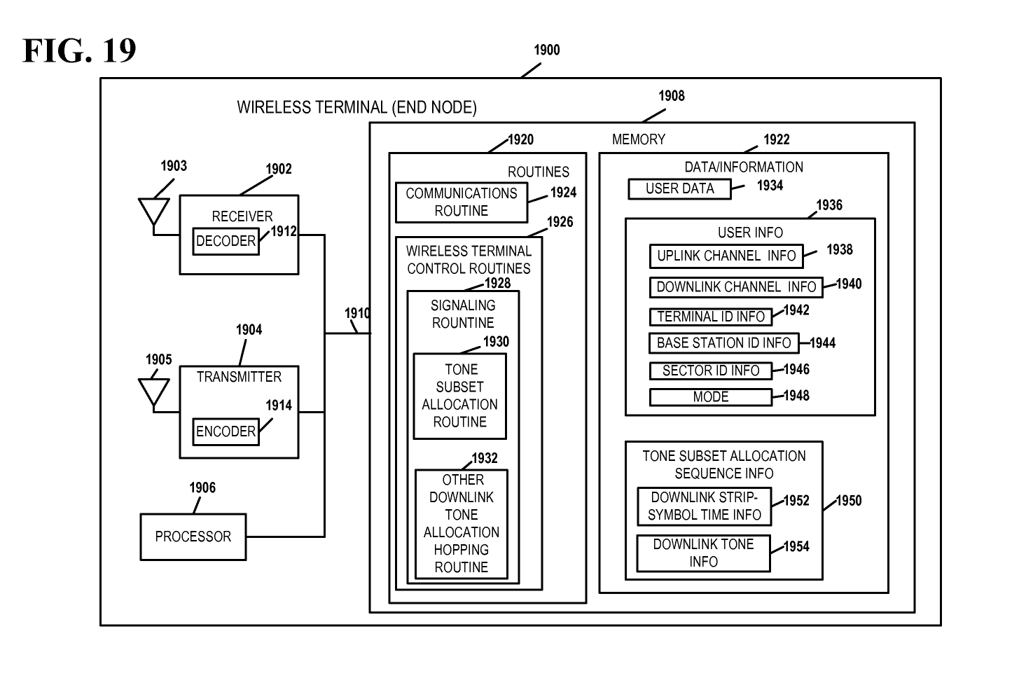

Sectorized antenna 1803 coupled to receiver 1802 is used for receiving data and other signals, e.g., channel reports, from wireless terminals transmissions from each sector within the base station's cell. Sectorized antenna 1805 coupled to transmitter 1804 is used for transmitting data and other signals, e.g., control signals, pilot signal, beacon signals, etc. to wireless terminals 1900 (see FIG. 19) within each sector of the base station's cell. In various aspects, base station 1800 may employ multiple receivers 1802 and multiple transmitters 1804, e.g., an individual receivers 1802 for each sector and an individual transmitter 1804 for each sector. Processor 1806, may be, e.g., a general purpose central processing unit (CPU). Processor 1806 controls operation of base station 1800 under direction of one or more routines 1818 stored in memory 1810 and implements the methods. I/O interface 1808 provides a connection to other network nodes, coupling the BS 1800 to other base stations, access routers, AAA server nodes, etc., other networks, and the Internet. Memory 1810 includes routines 1818 and data/information 1820.

Data/information 1820 includes data 1836, tone subset allocation sequence information 1838 including downlink strip-symbol time information 1840 and downlink tone information 1842, and wireless terminal (WT) data/info 1844 including a plurality of sets of WT information: WT 1 info 1846 and WT N info 1860. Each set of WT info, e.g., WT 1 info 1846 includes data 1848, terminal ID 1850, sector ID 1852, uplink channel information 1854, downlink channel information 1856, and mode information 1858.

Routines 1818 include communications routines 1822 and base station control routines 1824. Base station control routines 1824 includes a scheduler module 1826 and signaling routines 1828 including a tone subset allocation routine 1830 for strip-symbol periods, other downlink tone allocation hopping routine 1832 for the rest of symbol periods, e.g., non strip-symbol periods, and a beacon routine 1834.

Data 1836 includes data to be transmitted that will be sent to encoder 1814 of transmitter 1804 for encoding prior to transmission to WTs, and received data from WTs that has been processed through decoder 1812 of receiver 1802 following reception. Downlink strip-symbol time information 1840 includes the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone information 1842 includes information including a carrier frequency assigned to the base station 1800, the number and frequency of tones, and the set of tone subsets to be allocated to the strip-symbol periods, and other cell and sector specific values such as slope, slope index and sector type.

Data 1848 may include data that WT1 1900 has received from a peer node, data that WT 1 1900 desires to be transmitted to a peer node, and downlink channel quality report feedback information. Terminal ID 1850 is a base station 1800 assigned ID that identifies WT 1 1900. Sector ID 1852 includes information identifying the sector in which WT1 1900 is operating. Sector ID 1852 can be used, for example, to determine the sector type. Uplink channel information 1854 includes information identifying channel segments that have been allocated by scheduler 1826 for WT1 1900 to use, e.g., uplink traffic channel segments for data, dedicated uplink control channels for requests, power control, timing control, etc. Each uplink channel assigned to WT1 1900 includes one or more logical tones, each logical tone following an uplink hopping sequence. Downlink channel information 1856 includes information identifying channel segments that have been allocated by scheduler 1826 to carry data and/or information to WT1 1900, e.g., downlink traffic channel segments for user data. Each downlink channel assigned to WT1 1900 includes one or more logical tones, each following a downlink hopping sequence. Mode information 1858 includes information identifying the state of operation of WT1 1900, e.g. sleep, hold, on.

Communications routines 1822 control the base station 1800 to perform various communications operations and implement various communications protocols. Base station control routines 1824 are used to control the base station 1800 to perform basic base station functional tasks, e.g., signal generation and reception, scheduling, and to implement the steps of the method of some aspects including transmitting signals to wireless terminals using the tone subset allocation sequences during the strip-symbol periods.

Signaling routine 1828 controls the operation of receiver 1802 with its decoder 1812 and transmitter 1804 with its encoder 1814. The signaling routine 1828 is responsible controlling the generation of transmitted data 1836 and control information. Tone subset allocation routine 1830 constructs the tone subset to be used in a strip-symbol period using the method of the aspect and using data/info 1820 including downlink strip-symbol time info 1840 and sector ID 1852. The downlink tone subset allocation sequences will be different for each sector type in a cell and different for adjacent cells. The WTs 1900 receive the signals in the strip-symbol periods in accordance with the downlink tone subset allocation sequences; the base station 1800 uses the same downlink tone subset allocation sequences in order to generate the transmitted signals. Other downlink tone allocation hopping routine 1832 constructs downlink tone hopping sequences, using information including downlink tone information 1842, and downlink channel information 1856, for the symbol periods other than the strip-symbol periods. The downlink data tone hopping sequences are synchronized across the sectors of a cell. Beacon routine 1834 controls the transmission of a beacon signal, e.g., a signal of relatively high power signal concentrated on one or a few tones, which may be used for synchronization purposes, e.g., to synchronize the frame timing structure of the downlink signal and therefore the tone subset allocation sequence with respect to an ultra-slot boundary.

### Exemplary Wireless Terminal

FIG. 19 illustrates an example wireless terminal (end node) 1900 which can be used as any one of the wireless terminals (end nodes), e.g., EN(1) 1736, of the system 1700 shown in FIG. 17. Wireless terminal 1900 implements the tone subset allocation sequences. The wireless terminal 1900 includes a receiver 1902 including a decoder 1912, a transmitter 1904 including an encoder 1914, a processor 1906, and memory 1908 which are coupled together by a bus 1910 over which the various elements 1902, 1904, 1906, 1908 can interchange data and information. An antenna 1903 used for receiving signals from a base station (and/or a disparate wireless terminal) is coupled to receiver 1902. An antenna 1905 used for transmitting signals, e.g., to a base station (and/or a disparate wireless terminal) is coupled to transmitter 1904.

The processor 1906, e.g., a CPU controls the operation of the wireless terminal 1900 and implements methods by executing routines 1920 and using data/information 1922 in memory 1908.

Data/information 1922 includes user data 1934, user information 1936, and tone subset allocation sequence information 1950. User data 1934 may include data, intended for a peer node, which will be routed to encoder 1914 for encoding prior to transmission by transmitter 1904 to a base station, and data received from the base station which has been processed by the decoder 1912 in receiver 1902. User information 1936 includes uplink channel information 1938, downlink channel information 1940, terminal ID information 1942, base station ID information 1944, sector ID information 1946, and mode information 1948. Uplink channel information 1938 includes information identifying uplink channels segments that have been assigned by a base station for wireless terminal 1900 to use when transmitting to the base station. Uplink channels may include uplink traffic channels, dedicated uplink control channels, e.g., request channels, power control channels and timing control channels. Each uplink channel includes one or more logic tones, each logical tone following an uplink tone hopping sequence. The uplink hopping sequences are different between each sector type of a cell and between adjacent cells. Downlink channel information 1940 includes information identifying downlink channel segments that have been assigned by a base station to WT 1900 for use when the base station is transmitting data/information to WT 1900. Downlink channels may include downlink traffic channels and assignment channels, each downlink channel including one or more logical tone, each logical tone following a downlink hopping sequence, which is synchronized between each sector of the cell.

User info 1936 also includes terminal ID information 1942, which is a base station-assigned identification, base station ID information 1944 which identifies the specific base station that WT has established communications with, and sector ID info 1946 which identifies the specific sector of the cell where WT 1900 is presently located. Base station ID 1944 provides a cell slope value and sector ID info 1946 provides a sector index type; the cell slope value and sector index type may be used to derive tone hopping sequences. Mode information 1948 also included in user info 1936 identifies whether the WT 1900 is in sleep mode, hold mode, or on mode.

Tone subset allocation sequence information 1950 includes downlink strip-symbol time information 1952 and downlink tone information 1954. Downlink strip-symbol time information 1952 include the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone info 1954 includes information including a carrier frequency assigned to the base station, the number and frequency of tones, and the set of tone subsets to be allocated to the strip-symbol periods, and other cell and sector specific values such as slope, slope index and sector type.

Routines 1920 include communications routines 1924 and wireless terminal control routines 1926. Communications routines 1924 control the various communications protocols used by WT 1900. Wireless terminal control routines 1926 controls basic wireless terminal 1900 functionality including the control of the receiver 1902 and transmitter 1904. Wireless terminal control routines 1926 include the signaling routine 1928. The signaling routine 1928 includes a tone subset allocation routine 1930 for the strip-symbol periods and an other downlink tone allocation hopping routine 1932 for the rest of symbol periods, e.g., non strip-symbol periods. Tone subset allocation routine 1930 uses user data/info 1922 including downlink channel information 1940, base station ID info 1944, e.g., slope index and sector type, and downlink tone information 1954 in order to generate the downlink tone subset allocation sequences in accordance with some aspects and process received data transmitted from the base station. Other downlink tone allocation hopping routine 1930 constructs downlink tone hopping sequences, using information including downlink tone information 1954, and downlink channel information 1940, for the symbol periods other than the strip-symbol periods. Tone subset allocation routine 1930, when executed by processor 1906, is used to determine when and on which tones the wireless terminal 1900 is to receive one or more strip-symbol signals from the base station 1800. The uplink tone allocation hopping routine 1930 uses a tone subset allocation function, along with information received from the base station, to determine the tones in which it should transmit on.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

When the embodiments are implemented in program code or code segments, it should be appreciated that a code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc. Additionally, in some aspects, the steps and/or actions of a method or algorithm can reside as one or any combination or set of codes and/or instructions on a machine readable medium and/or computer readable medium, which can be incorporated into a computer program product.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A method that facilitates an early processing of relay signals, the method comprising:
receiving a signal within a sub-frame, wherein the signal is associated with a relay;
detecting a first reference symbol and a second reference symbol within the sub-frame, wherein the first reference symbol is detected before the second reference symbol; and
decoding the signal based on the first reference symbol.

2. The method of claim 1, wherein the first reference symbol and the second reference symbol are associated with a demodulation reference signal.

3. The method of claim 1, wherein the sub-frame is a hybrid sub-frame which includes frequency division multiplexing and time division multiplexing.

4. The method of claim 1, wherein the sub-frame is a pure frequency division multiplexing sub-frame.

5. The method of claim 4, wherein the signal is included in a Relay Physical Downlink Control Channel.

6. The method of claim 5, wherein the signal is included in a plurality of signals respectively corresponding to different relays, and wherein the Relay Physical Downlink Control Channel includes the plurality of signals.

7. The method of claim 4, wherein the signal is included in a Relay Physical Downlink Shared Channel.

8. The method of claim 7, wherein the signal is included in a plurality of signals respectively corresponding to different relays, and wherein the Relay Physical Downlink Shared Channel includes the plurality of signals.

9. The method of claim 4, wherein the signal is included in a first portion of a resource block, and wherein the signal is repeated in a second portion of the resource block received after the first portion.

10. The method of claim 9, wherein the decoding comprises attempting to decode the signal via the first portion of the resource block, and wherein the decoding further comprises performing a subsequent decoding of the signal via the second portion of the resource block if the signal is unsuccessfully decoded via the first portion.

11. The method of claim 4, wherein a plurality of signals respectively corresponding to a plurality of relays are included in a resource block, and wherein the signal is included in the plurality of signals.

12. The method of claim 11, wherein the plurality of signals are included in a first portion of the resource block, and wherein the plurality of signals are repeated in a second portion of the resource block received after the first portion.

13. The method of claim 11, wherein the signal is biased towards a first portion of the resource block, and wherein a remainder of the plurality of signals is biased towards a second portion of the resource block received after the first portion.

14. The method of claim 11, wherein the signal is included in a first portion of the resource block, and wherein a different signal associated with a different relay is included in a second portion of the resource block received after the first portion.

15. The method of claim 1, wherein the decoding further comprises identifying a unique parameter associated with the signal, and wherein the unique parameter is at least one of a power level, a resource level, or an aggregation level.

16. The method of claim 1, wherein the decoding further comprises distinguishing different pre-coding vectors respectively associated with different slots within the sub-frame.

17. The method of claim 1, wherein the decoding further comprises identifying a power boost applied to data tones associated with the signal, and wherein the first reference symbol and the second reference symbol are excluded from the power boost.

18. The method of claim 1, wherein a Relay Physical Hybrid Automatic Repeat Request Indicator Channel is received in a resource block dedicated to a Relay Physical Downlink Control Channel.

19. The method of claim 18, wherein the decoding further comprises mapping resources associated with the Relay Physical Hybrid Automatic Repeat Request Indicator Channel exclusively to a portion of the sub-frame that includes at least one of a set of uplink grants or a set of downlink grants.

20. The method of claim 4, the signal including a set of uplink grants and a set of downlink grants, wherein the set of downlink grants are included in a first portion of a resource block, and wherein the set of uplink grants are included in a second portion of the resource block received after the first portion.

21. An apparatus configured to facilitate an early processing of relay signals, the apparatus comprising:
a processor configured to execute computer executable components stored in memory, the components including:
a communication component configured to receive a signal within a sub-frame, wherein the signal is associated with a relay;
a reference component configured to detect a first reference symbol and a second reference symbol within the sub-frame, wherein the first reference symbol is detected before the second reference symbol; and
a decoding component configured to decode the signal based on the first reference symbol.

22. The apparatus of claim 21, wherein the first reference symbol and the second reference symbol are associated with a demodulation reference signal.

23. The apparatus of claim 21, wherein the sub-frame is a hybrid sub-frame which includes frequency division multiplexing and time division multiplexing.

24. The apparatus of claim 21, wherein the sub-frame is a pure frequency division multiplexing sub-frame.

25. The apparatus of claim 24, wherein the signal is included in a Relay Physical Downlink Control Channel.

26. The apparatus of claim 25, wherein the signal is included in a plurality of signals respectively corresponding to different relays, and wherein the Relay Physical Downlink Control Channel includes the plurality of signals.

27. The apparatus of claim 24, wherein the signal is included in a Relay Physical Downlink Shared Channel.

28. The apparatus of claim 27, wherein the signal is included in a plurality of signals respectively corresponding to different relays, and wherein the Relay Physical Downlink Shared Channel includes the plurality of signals.

29. The apparatus of claim 24, wherein the signal is included in a first portion of a resource block, and wherein the signal is repeated in a second portion of the resource block received after the first portion.

30. The apparatus of claim 29, wherein the decoding component is configured to attempt to decode the signal via the first portion of the resource block, and wherein the decoding component is further configured to perform a subsequent decoding of the signal via the second portion of the resource block if the signal is unsuccessfully decoded via the first portion.

31. The apparatus of claim 24, wherein a plurality of signals respectively corresponding to a plurality of relays are included in a resource block, and wherein the signal is included in the plurality of signals.

32. The apparatus of claim 31, wherein the plurality of signals are included in a first portion of the resource block, and wherein the plurality of signals are repeated in a second portion of the resource block received after the first portion.

33. The apparatus of claim 31, wherein the signal is biased towards a first portion of the resource block, and wherein a remainder of the plurality of signals is biased towards a second portion of the resource block received after the first portion.

34. The apparatus of claim 31, wherein the signal is included in a first portion of the resource block, and wherein a different signal associated with a different relay is included in a second portion of the resource block received after the first portion.

35. The apparatus of claim 21, wherein the decoding component is configured to identify a unique parameter associated with the signal, and wherein the unique parameter is at least one of a power level, a resource level, or an aggregation level.

36. The apparatus of claim 21, wherein the decoding component is configured to distinguish different pre-coding vectors respectively associated with different slots within the sub-frame.

37. The apparatus of claim 21, wherein the decoding component is configured to identify a power boost applied to data tones associated with the signal, and wherein the first reference symbol and the second reference symbol are excluded from the power boost.

38. The apparatus of claim 21, wherein the communication component is configured to receive a Relay Physical Hybrid Automatic Repeat Request Indicator Channel in a resource block dedicated to a Relay Physical Downlink Control Channel.

39. The apparatus of claim 38, wherein the decoding component is configured to map resources associated with the Relay Physical Hybrid Automatic Repeat Request Indicator Channel exclusively to a portion of the sub-frame that includes at least one of a set of uplink grants or a set of downlink grants.

40. The apparatus of claim 24, the signal including a set of uplink grants and a set of downlink grants, wherein the set of downlink grants are included in a first portion of a resource block, and wherein the set of uplink grants are included in a second portion of the resource block received after the first portion.

41. A computer program product that facilitates an early processing of relay signals, comprising:
a computer-readable storage medium comprising code for causing at least one computer to:
receive a signal within a sub-frame, wherein the signal is associated with a relay;
detect a first reference symbol and a second reference symbol within the sub-frame, wherein the first reference symbol is detected before the second reference symbol; and
decode the signal based on the first reference symbol.

42. The computer program product of claim 41, wherein the sub-frame is a pure frequency division multiplexing sub-frame.

43. The computer program product of claim 42, the signal including a set of uplink grants and a set of downlink grants, wherein the set of downlink grants are included in a first portion of a resource block, and wherein the set of uplink grants are included in a second portion of the resource block received after the first portion.

44. An apparatus configured to facilitate an early processing of relay signals, the apparatus comprising:
means for receiving a signal within a sub-frame, wherein the signal is associated with a relay;
means for detecting a first reference symbol and a second reference symbol within the sub-frame, wherein the first reference symbol is detected before the second reference symbol; and
means for decoding the signal based on the first reference symbol.

45. The apparatus of claim 44, wherein the means for decoding is configured to identify a unique parameter associated with the signal, and wherein the unique parameter is at least one of a power level, a resource level, or an aggregation level.

46. The apparatus of claim 44, wherein the means for decoding is configured to distinguish different pre-coding vectors respectively associated with different slots within the sub-frame.

47. A method that facilitates an early processing of relay signals, the method comprising:
generating a signal within a sub-frame, wherein the signal is associated with a relay;
providing a first reference symbol and a second reference symbol within the sub-frame, wherein the first reference symbol is provided before the second reference symbol; and
transmitting the signal to the relay, wherein the signal is decodable based on the first reference symbol.

48. The method of claim 47, wherein the first reference symbol and the second reference symbol are associated with a demodulation reference signal.

49. The method of claim 47, wherein the sub-frame is a hybrid sub-frame which includes frequency division multiplexing and time division multiplexing.

50. The method of claim 47, wherein the sub-frame is a pure frequency division multiplexing sub-frame.

51. The method of claim 50, wherein the transmitting comprises including the signal in a Relay Physical Downlink Control Channel.

52. The method of claim 51, wherein the signal is included in a plurality of signals respectively corresponding to different relays, and wherein the Relay Physical Downlink Control Channel includes the plurality of signals.

53. The method of claim 50, wherein the transmitting comprises including the signal in a Relay Physical Downlink Shared Channel.

54. The method of claim 53, wherein the signal is included in a plurality of signals respectively corresponding to different relays, and wherein the Relay Physical Downlink Shared Channel includes the plurality of signals.

55. The method of claim 50, wherein the generating comprises including the signal in a first portion of a resource block, and wherein the generating further comprises repeating the signal in a second portion of the resource block transmitted after the first portion.

56. The method of claim 50, wherein the generating comprises including a plurality of signals respectively corresponding to a plurality of relays in a resource block, and wherein the signal is included in the plurality of signals.

57. The method of claim 56, wherein the generating comprises including the plurality of signals in a first portion of the resource block, and wherein the generating further comprises repeating the plurality of signals in a second portion of the resource block transmitted after the first portion.

58. The method of claim 56, wherein the generating comprises biasing the signal towards a first portion of the resource block, and wherein a remainder of the plurality of signals is biased towards a second portion of the resource block transmitted after the first portion.

59. The method of claim 56, wherein the generating comprises including the signal in a first portion of the resource block, and wherein a different signal associated with a different relay is included in a second portion of the resource block transmitted after the first portion.

60. The method of claim 47, wherein the generating comprises associating a unique parameter with the signal, and wherein the unique parameter is at least one of a power level, a resource level, or an aggregation level.

61. The method of claim 47, wherein the generating comprises utilizing different pre-coding vectors respectively associated with different slots within the sub-frame.

62. The method of claim 47, wherein the transmitting comprises applying a power boost to data tones associated with the signal, and wherein the transmitting further comprises excluding the first reference symbol and the second reference symbol from the power boost.

63. The method of claim 47, wherein the generating comprises including a Relay Physical Hybrid Automatic Repeat Request Indicator Channel in a resource block dedicated to a Relay Physical Downlink Control Channel.

64. The method of claim 63, wherein the generating comprises mapping resources associated with the Relay Physical Hybrid Automatic Repeat Request Indicator Channel exclusively to a portion of the sub-frame that includes at least one of a set of uplink grants or a set of downlink grants.

65. The method of claim 50, the signal including a set of uplink grants and a set of downlink grants, wherein the generating comprises including the set of downlink grants in a first portion of a resource block, and wherein the set of uplink grants are included in a second portion of the resource block transmitted after the first portion.

66. An apparatus configured to facilitate an early processing of relay signals, the apparatus comprising:
a processor configured to execute computer executable components stored in memory, the components including:
a generation component configured to generate a signal within a sub-frame, wherein the signal is associated with a relay;
a reference component configured to provide a first reference symbol and a second reference symbol within the sub-frame, wherein the first reference symbol is provided before the second reference symbol; and
a communication component configured to transmit the signal to the relay, wherein the signal is decodable based on the first reference symbol.

67. The apparatus of claim 66, wherein the first reference symbol and the second reference symbol are associated with a demodulation reference signal.

68. The apparatus of claim 66, wherein the sub-frame is a hybrid sub-frame which includes frequency division multiplexing and time division multiplexing.

69. The apparatus of claim 66, wherein the sub-frame is a pure frequency division multiplexing sub-frame.

70. The apparatus of claim 69, wherein the communication component is configured to include the signal in a Relay Physical Downlink Control Channel.

71. The apparatus of claim 70, wherein the signal is included in a plurality of signals respectively corresponding to different relays, and wherein the Relay Physical Downlink Control Channel includes the plurality of signals.

72. The apparatus of claim 69, wherein the communication component is configured to include the signal in a Relay Physical Downlink Shared Channel.

73. The apparatus of claim 72, wherein the signal is included in a plurality of signals respectively corresponding to different relays, and wherein the Relay Physical Downlink Shared Channel includes the plurality of signals.

74. The apparatus of claim 69, wherein the generation component is configured to include the signal in a first portion of a resource block, and wherein the generation component is configured to repeat the signal in a second portion of the resource block transmitted after the first portion.

75. The apparatus of claim 69, wherein the generation component is configured to include a plurality of signals respectively corresponding to a plurality of relays in a resource block, and wherein the signal is included in the plurality of signals.

76. The apparatus of claim 75, wherein the generation component is configured to include the plurality of signals in a first portion of the resource block, and wherein the generation component is further configured to repeat the plurality of signals in a second portion of the resource block transmitted after the first portion.

77. The apparatus of claim 75, wherein the generation component is configured to bias the signal towards a first portion of the resource block, and wherein a remainder of the plurality of signals is biased towards a second portion of the resource block transmitted after the first portion.

78. The apparatus of claim 75, wherein the generation component is configured to include the signal in a first portion of the resource block, and wherein a different signal associated with a different relay is included in a second portion of the resource block transmitted after the first portion.

79. The apparatus of claim 66, wherein the generation component is configured to associate a unique parameter with the signal, and wherein the unique parameter is at least one of a power level, a resource level, or an aggregation level.

80. The apparatus of claim 66, wherein the generation component is configured to utilize different pre-coding vectors respectively associated with different slots within the sub-frame.

81. The apparatus of claim 66, wherein the communication component is configured to apply a power boost to data tones associated with the signal, and wherein the communication component is further configured to exclude the first reference symbol and the second reference symbol from the power boost.

82. The apparatus of claim 66, wherein the generation component is configured to include a Relay Physical Hybrid Automatic Repeat Request Indicator Channel in a resource block dedicated to a Relay Physical Downlink Control Channel.

83. The apparatus of claim 82, wherein the generation component is configured to map resources associated with the Relay Physical Hybrid Automatic Repeat Request Indicator Channel exclusively to a portion of the sub-frame that includes at least one of a set of uplink grants or a set of downlink grants.

84. The apparatus of claim 69, the signal including a set of uplink grants and a set of downlink grants, wherein the generation component is configured to include the set of downlink grants in a first portion of a resource block, and wherein the set of uplink grants are included in a second portion of the resource block transmitted after the first portion.

85. A computer program product that facilitates an early processing of relay signals, comprising:
a computer-readable storage medium comprising code for causing at least one computer to:
generate a signal within a sub-frame, wherein the signal is associated with a relay;
provide a first reference symbol and a second reference symbol within the sub-frame, wherein the first reference symbol is provided before the second reference symbol; and
transmit the signal to the relay, wherein the signal is decodable based on the first reference symbol.

86. The computer program product of claim 85, wherein the sub-frame is a pure frequency division multiplexing sub-frame.

87. The computer program product of claim 86, the signal including a set of uplink grants and a set of downlink grants, wherein the set of downlink grants are included in a first portion of a resource block, and wherein the set of uplink grants are included in a second portion of the resource block received after the first portion.

88. An apparatus configured to facilitate an early processing of relay signals, the apparatus comprising:
means for generating a signal within a sub-frame, wherein the signal is associated with a relay;
means for providing a first reference symbol and a second reference symbol within the sub-frame, wherein the first reference symbol is provided before the second reference symbol; and
means for transmitting the signal to the relay, wherein the signal is decodable based on the first reference symbol.

89. The apparatus of claim 88, wherein the means for generating is configured to associate a unique parameter with the signal, and wherein the unique parameter is at least one of a power level, a resource level, or an aggregation level.

90. The apparatus of claim 88, wherein the means for generating is configured to utilize different pre-coding vectors respectively associated with different slots within the sub-frame.
